(19) United States
(12) Patent Application Publication
(10) Pub. No.: US 2013/0332521 A1
(43) Pub. Date: Dec. 12, 2013

(54) SYSTEMS AND METHODS FOR COMPILING MEDIA INFORMATION BASED ON PRIVACY AND RELIABILITY METRICS

(71) Applicants: Craig Alan Olague, Moorpark, CA (US); Neel Suhas Ketkar, Santa Monica, CA (US); Henry C. Chilvers, JR., Valencia, CA (US); Walter R. Klappert, Los Angeles, CA (US)

(72) Inventors: Craig Alan Olague, Moorpark, CA (US); Neel Suhas Ketkar, Santa Monica, CA (US); Henry C. Chilvers, JR., Valencia, CA (US); Walter R. Klappert, Los Angeles, CA (US)

(73) Assignee: UNITED VIDEO PROPERTIES, INC., Santa Clara, CA (US)

(21) Appl. No.: 13/490,704

(22) Filed: Jun. 7, 2012

(51) Int. Cl. G06F 15/16

(52) U.S. Cl. 709/204

(57) ABSTRACT

Methods and systems for creating a user profile clearinghouse server, which combines information available from multiple sources and filters the information based on both privacy settings and reliability to create a profile of a user's media content interests.

### BACKGROUND OF THE INVENTION

In conventional television systems, information regarding whether or not a user watches a particular media program is often tracked. Tracking the viewing habits of a user allows systems to predict what the user wishes to watch. Without having to question the user directly, the system may gain valuable insight into the interests of the user. Tracked information may then be used to target particular media, for example, recommended programs or advertisements, to a user.

Other systems or servers also track user activity as well. For example, a website may track the activity of a user of that website. The website may use that information to better understand the interests of the user. The website may then use the accumulated interests to, for example, recommend content featured on the website that may be of interest to the user.

Tracking may result from monitoring and/or recording a user's activities (e.g., programs or website pages viewed, or “clicked on” by a user) and amassing a database of the activities related to a user. As the breadth and scope of tracking information has increased, however, privacy concerns have become a pressing issue. Systems that track information are therefore often restricted by privacy settings that a user may configure to limit how the user's interests are monitored. Moreover, the information that is collected in those systems is often further restricted by the privacy settings regarding how and with whom the collected information may be shared. The diffuse storage of users' interests and the restrictiveness of privacy settings have made it increasingly difficult to obtain useful information on a user's interests from multiple sources in order to provide targeted media content to that user.

### SUMMARY OF THE INVENTION

Accordingly, methods and systems are described herein for generating a user profile clearinghouse server, which combines information available from multiple sources and filters the information based on both privacy settings and reliability to create a profile of a user's media content interests.

In many cases, a particular requester may need to access information about the media content interests of a user, such as the user's favorite movie genre. By interfacing with a plurality of sources such as user devices, third party accounts and third party services across a network, a profile clearinghouse server can reliably compile information on the particular user's media content interests. Furthermore, the characteristics of the profile clearinghouse server allow the server to navigate the privacy settings for information about a user on a plurality of sources and to provide a user profile, in accordance with those settings and with a determined reliability, to a requester.

In order to compile a user profile from multiple sources, the profile clearinghouse server filters information from various sources according to both the privacy settings of the information about the user on the sources and the reliability of the information. For example, a user may indicate, or information may have been collected according to privacy settings, which dictate, that the information may only be provided to certain requesters. A requester interested in obtaining the information may not know what information, if any, is available based on the privacy settings. Furthermore, the requester may not have access to the databases of multiple sources to determine what information is available from each source. Furthermore, even if a requester obtains access to the information contained at a particular source, the requester would not know the reliability of that information.

The profile clearinghouse server acts as an intermediary between the requester and the sources. The profile clearinghouse server is specifically configured to parse multiple databases of a plurality of sources to derive a “universal profile” for a particular user. In addition to compiling information on a particular user, the profile clearinghouse server may interpret the privacy settings on how and with whom information from each source may be shared. Because the profile clearinghouse server has access to the databases of multiple sources, the profile clearinghouse server may interpret the privacy settings before receiving a request for information. The profile clearinghouse server may then provide indications of the type and amount of data available on particular person, which may vary depending on the identity of the requester.

The profile clearinghouse server is further configured to determine the reliability of the compiled information. The reliability of the information may indicate a likelihood that the media content interests supplied by the information from the source are indicative of the user's media content interests. For example, a set-top box may be registered to a user in a residence; however, multiple people may be use the set-top box within the residence. Therefore, even if information from the set-top box indicates that a particular show is the most frequently watched show on the set-top box, the show may not be the most frequently watched show by the user.

The reliability of the information may be valued by a reliability metric. The reliability metric may be determined by comparing information about the source to defined guidelines. For example, the reliability of a source may be determined by assigning the type of source (e.g., a person's social media page) a value according to a guideline value for a source of that type (e.g., information on a social media page may be considered “highly” reliable). In addition, each source may have different methods or standards for collecting and/or verifying information, which may be accounted for in the reliability guidelines.

Therefore, the profile clearinghouse server compares the reliability of each source when determining whether or not to provide or use information from that source and/or provides the information with an indication of its reliability. For example, information from a particular source may relate to a different user (e.g., the information may relate to two users with the same name), be out-of-date (e.g., the information may include the prior address of a user), or not be indicative of actions actually performed by the user (e.g., the information may relate to tracked actions of another person using a computer registered to the user).

Therefore, by parsing multiple databases of a plurality of sources for information on a particular user, filtering information according to the privacy settings of user information on each source, and comparing filtered information to determine its reliability, the profile clearinghouse server may generate and transmit a “universal” user profile that includes accessible and reliable information on a user's media content interests.

In some embodiments, profiling a user's media content interests is initiated when the server receives a request from a requester for a user profile, which includes a user's media content interests. The request may include a requester identifier that identifies the requester. The server accesses a data structure of a source, which includes media content interests and privacy settings. The requester identifier may then be compared to the privacy setting to determine whether the requester has access to the user information on the source. The server retrieves the first media content interests from the data structure of the source in response to determining the requester has access to the source. The server extrapolates a reliability metric from the source, in which the reliability metric indicates a likelihood that the media content interests are indicative of the user's media content interests. The server compares the reliability metric to a reliability metric threshold. In response to determining the reliability metric exceeds the reliability metric threshold, the server generates the user profile based at least in part on the first media content interests and transmits the user profile to the requester.

In some embodiments, another source, which includes media content interests, may also be used to generate the user profile. In addition, the sources used to generate the user profile may be of different types. The sources may also be weighted based on the reliability metric of the respective source. The weighted sources may also be used to generate composite media content interests based on the weighted media content interests from the sources.

In some embodiments, the user profile may include a numerical indication of the reliability that the media content interests in the user profile are indicative of the media content interests of the user. In some embodiments, the server may generate verifying media content interests from sources that are inaccessible to the requester. Generating verifying media content interests may include generating a verification metric, which indicates the consistency between the media content interests in the user profile and the verifying media content interests.

In some embodiments, the server may also identify sources that include media content interests related to the user from a plurality of sources by comparing the consistency of media content interests of the user at the profile clearinghouse server to media content interests of the user at the plurality of sources. In some embodiments, the server may access a source, which includes media content interests and privacy settings before receiving the query from the requester.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 is an illustrative diagram of a profile clearinghouse system in accordance with some embodiments of the disclosure;

FIG. 2 is a block diagram of an illustrative profile clearinghouse system in accordance with some embodiments of the disclosure;

FIG. 3 is a block diagram of an illustrative system used in accordance with some embodiments of the disclosure;

FIG. 4 is an illustrative diagram of a profile clearinghouse system in accordance with some embodiments of the disclosure;

FIG. 5 is a flowchart of illustrative steps involved in providing a user profile in accordance with some embodiments of the disclosure;

FIG. 6 is an illustrative diagram of the data structures of a plurality of sources in accordance with some embodiments of the disclosure;

FIG. 7 is an illustrative diagram of the media content interests and source information data structures of two sources in accordance with some embodiments of the disclosure;

FIG. 8 is an illustrative diagram of some embodiments of the disclosure comparing media content interests and device information of a plurality of sources to determine a user profile;

FIG. 9 shows another exemplary data structure for a transmission from a source in accordance with some embodiments of the disclosure;

FIG. 10 shows another exemplary data structure for a transmission from a source in accordance with some embodiments of the disclosure;

FIG. 11 shows an exemplary data structure for a user profile for transmission from a profile clearinghouse server in accordance with some embodiments of the disclosure;

FIG. 12 is a flowchart of illustrative steps involved in interpreting the privacy settings for information on multiple sources in accordance with some embodiments of the disclosure;

FIG. 13 is a flowchart of illustrative steps involved in determining the value of a reliability metric in accordance with some embodiments of the disclosure;

FIG. 14 is a flowchart of illustrative steps involved in determining and outputting the weighted media content interest value for a user profile in accordance with some of the embodiments of the disclosure;

FIG. 15 is a flowchart of illustrative steps involved using media content interests from any non-accessible sources to verify a user profile in accordance with some of the embodiments of the disclosure;

FIG. 16 is a more detailed flowchart of illustrative steps involved in using media content interests from any non-accessible sources to verify a user profile in accordance with some embodiments of the disclosure; and

FIG. 17 is a flowchart of illustrative steps involved in determining a verification metric by using media content interests from any non-accessible sources to verify a user profile in accordance with some of the embodiments of the disclosure.

### DETAILED DESCRIPTION OF THE INVENTION

The amount of content available on a user in any given media content delivery system can be substantial. Consequently, many requesters may desire a profile that allows the requester to easily identify media content interests of a particular user or group. An application that provides such profiling is referred to herein as a profile clearinghouse application. The profile clearinghouse application may be performed on a profile clearinghouse server. The user profile may include information from one source, multiple sources, or one or more other profiles.

A requester, as used herein, is any person, group, entity, system, which requests a user profile on any user from the profile clearinghouse application. A requester may issue a request, which indicates what information (e.g., information on a specific person, group, device, entity, service, or combination thereof) the requester is seeking to the profile clearinghouse application. As used herein, the profile clearinghouse application is the application, which provides a profile to the requester in response to its request.

User profiles, as used herein, are compilations of media content interests of a user. Media content interests relate to information on a user, or a group of users, in relation to media content, which may include preferences, actions or decisions related to the performance, distribution, recommendation, creation or consumption (including purchasing) of media content. For example, media content interests may include a user's favorites, likes, dislikes, ratings, critical reviews, or recommendations in regards to a media asset, shows or series currently being watched, shows or series likely to be watched, the time a user typically watches a show or series, or the genre of the show or series typically watched by the user.

Furthermore, a user profile may include demographic information related to a user such as traits regarding the user that indicate a relationship to the performance, distribution, recommendation, creation or consumption of media content, which may be incorporated into the media content interests. For example, a user profile may contain the age, gender, income level, marital status, race and/or ethnicity of the user as any of these traits may suggest a particular media content interest of a user. In addition, the profile may include user viewing histories, market research relating to the user, industry reports relating to the user, surveys, and/or interviews that may suggest particular media content is of interest to a user. This information may be incorporated into the media content interests. For example, an industry report may suggest that because the user is a particular age, the user is likely to enjoy a particular show.

Furthermore, the information contained in one profile may indicate that the profile has a relationship with another profile. As used herein, two profiles are related if both profiles include information regarding the subject of the request received by the requester. For example, a profile of media content interests of a person may be related to a profile of media content consumed on a tablet computer used/owned by the same person, if a requester requests information about the media interests of that person. In another example, a profile of media content streamed by a website, may be related to a profile of media content received by a tablet computer, if the requester requests information about content streamed to a tablet computer from the website. In another example, a profile of the media content interests of a particular person may be related to an account on a website used by the person. For example, a user may have an account for accessing and viewing streaming media content.

In some embodiments, the profile clearinghouse application may determine whether or not media content interests from a particular source are related to a user for which a request was received. To make this determination, the profile clearinghouse application may compare the consistency of media content interests from a particular source to the media content interests for the user at the profile clearinghouse server. For example, the profile clearinghouse server may have some media content interest for which it has determined are about a particular user (e.g., “John Smith”). A source may also have information about a person named “John Smith,” which may also refer to the user, or may refer to a person with the same name as the user. The profile clearinghouse server may compare the consistency of the information it has on the user (e.g., name, address, telephone number) to the same information about “John Smith” located on the source. If the information is determined to be a particular level of consistency, the profile clearinghouse server may determine that the person named “John Smith” at the source is the user.

A user profile may also include information about the source of the media content interests. In some embodiments, information about the source may be transmitted in or with the media content interests. In some embodiments, information on the source of the media content interests may be transmitted separately from the media content interests. Source information, as used herein, is information used to describe the source of the media content interests. Source information may describe the type of source (e.g., the type of device, entity or service), how the data was collected (e.g., customer questionnaires, billing information, information tracking), when the data was collected (e.g., on-time collection, periodic collection), how the data is stored (e.g., the data structure of the media content interests), rules governing the media content interests (e.g., privacy settings, if any), and any additional information about the media content interests that may be used to determine the reliability of the media content interests.

As referred to herein, a user may be defined as a person or group. For example, a user may be a single person, or a user may be a group of people. Furthermore, a user may be defined by a device owned/used by the user. For example, some embodiments could be applied to provide a profile of a particular device or devices, used by one or more people. It should also be noted that embodiments of this disclosure relating to a person or group may also be applied to entities, services, or combinations thereof, for which a profile is requested. For example, some embodiments could be applied to provide a profile of an entity or entities such as a corporation, website or industry. For example, some embodiments could be applied to provide a profile of a service, such as an account used to access streaming media content.

In some embodiments, a requester may wish to access information regarding any of these users (or any device, entity, service, or combination thereof). For example, a requester may wish to retrieve the top ten television shows streamed from a website last month by all of the people in the requester's database. In this case, the user profile may contain information on a group of people (e.g., the people in the database) and the actions in relation to an entity (e.g., the website). In another example, the user profile may contain information regarding the top ten shows streamed over the internet to smartphones used by a group of people (e.g., the people in the database). In this case, the user profile may contain information on a group of devices (e.g., smartphones) and the actions in relation to a service (e.g., streaming media over the internet). In another example, the user profile may contain information regarding the top ten shows streamed over the internet to all people. In this case the user profile may contain information on shows streamed over the internet to any person. It should be noted that all of the embodiments described herein directed to generating, modifying, transmitting, or otherwise using profiles for a user, may be adapted to generate, modify, transmit, or otherwise use profiles for devices, entities, services, or combinations thereof.

As referred to herein, a source of profile may be a person, group, device, entity, service, collection of information (e.g., a database), or anything else that may provide information relating to a user's media content interests. The source may include the systems of the profile clearinghouse server or third-party systems (e.g., remotely located databases whether or not the databases and the profile clearinghouse server are commonly owned). In addition, a source may have a type, and a plurality of sources used to create a user profile may include a plurality of types (e.g., a set-top box source, a tablet computer source, a smartphone source, and/or a website service source).

In the systems and methods of this disclosure, the information transmitted between the source and the profile clearinghouse application needs to be securely regulated especially regarding what information can be shared with whom, and which business rules (e.g., privacy and reliability) need to be considered when a specific requester requests information. To accomplish this, in some embodiments, identification of the requester of information is conveyed to the profile clearinghouse server. As user herein, the requester identifier is any type of indication with identifies the identity of the requester. For example, the requester's identity may be conveyed in a requester identifier in Application Program Interface (“API”) calls. The information returned in the profile by the profile clearinghouse application may be searched and filtered appropriately for this requester. In some embodiments, the profile clearinghouse server determines the identity of the requester without the requester providing a requester identifier.

Each source may have one or more privacy settings associated with the information contained at the source. As referred to herein, a privacy setting is a setting which regulates how, what, when, where and/or with whom information about a user located on a source may be shared. For example, a user (e.g., a person) may provide information to a source (e.g., a credit card company). The person may indicate, or the terms of the credit card company may dictate, that information supplied by the person is not to be shared with any other requester or source (e.g., an on-line advertiser). In some embodiments, some information from the same source may have different privacy settings. For example, the source (e.g., a credit card company) may be able to share a user's name with another source (e.g., an on-line advertiser), but not the user's address. In another example, the source (e.g., a credit card company) may be able to share a user's address with one source (e.g., a government entity), but not another source (e.g., an on-line advertiser).

The reliability of the information may also need to be confirmed before the system can provide the information to a requester. For example, the system may pull information from a variety of sources. Each source may have different methods or standards for collecting and/or verifying information. Therefore, the system may need to compare the reliability of each source when determining whether to provide or use information from that source. For example, information from a particular source may relate to a different user (e.g., providing information on two users with the same name), out-of-date information (e.g., providing information on the prior address of a user), or not indicative of actions actually performed by the user (e.g., providing tracking information on the actions of another person using the user's computer). The source of the information may consider the reliability of the information; therefore, the profile clearinghouse application may or may not need to determine whether or not the information is reliable enough to provide to a requester.

As used herein, the reliability of the information indicates a likelihood that the media content interests supplied by the source are indicative of the user's media content interests. The reliability of the information may be valued by a reliability metric. The reliability metric may be determined by comparing source information to defined guidelines, which determine the reliability of the source. For example, the reliability of a source may be determined by assigning the type of source (e.g., a person's social media page) a value according to a predetermined guideline value for a source of that type (e.g., information on a social media page is considered “highly” reliable). In addition, each source may have different methods or standards for collecting and/or verifying information as indicated by the source information, which may be applied to the reliability guidelines.

In some embodiments, the media content interests provided by a source may include an array of data fields. The profile clearinghouse application may use a lookup table data structure to assign a value to each data field as the profile clearinghouse application progresses through the array. For example, one data field may indicate that the source is a set-top box in a user's residence. The profile clearinghouse application may then input this information into the lookup table. The lookup table may return a value for the reliability of the information from the source. The system may use multiple types of object recognition, including fuzzy logic. For example, the particular data field may be a textual data field. Using fuzzy logic, the system may determine two fields to be identical even though the substance of the data field (e.g., two different spellings) is not identical.

The values assigned in the lookup table may be generated using industry information, historical analysis, past profile information, or any other suitable means to generate a value associated with a measure of whether or not information in a data field indicates a likelihood that the data field is a reliable indicator of the user's media content interests. For example, industry information may suggest that a set-top box in a user's residence is likely to be used by multiple people in addition to the user. Therefore, the value assigned for the occurrence of this particular data field in the lookup table may be low. In another example, a cross-reference of industry information with user profile information may indicate that the user lives alone; therefore, the set-top box in the user's residence is likely to be used by only the user. In another example, a data field provided by a source may indicate that the source is a user's personal social media webpage. Industry information suggests that a user's social media webpage is typically not used by people other than the user. Therefore, the value assigned for the occurrence of this particular data field in the lookup table may be high.

In addition, a particular data field may be compared to other data fields in the source before a value is assigned in the lookup table. For example, a data field may indicate that the source is a user's account on a streaming media website. Another data field may indicate that the media content interests (such as the genre of shows typically watched) are homogeneous. The profile clearinghouse application may determine that due to the homogenous nature of the media content interests, the information provided by the source is likely from only a single user, or that the user has specific media content interests. Therefore, the value assigned for the occurrence of this particular data field in the lookup table may be high.

In another example where a data field indicates that the source is a user's account on a streaming media website, another data field may indicate that the media content interests (such as the genre of shows typically watched) are not homogeneous. The profile clearinghouse application may determine that due to the non-homogenous nature of the media content interests, the information provided by the source is likely from multiple people (not only the user), or that the user has diverse media content interests. Therefore, the value assigned for the occurrence of this particular data field in the lookup table may be low.

In addition, the reliability of information from a source may also be subject to further reliability determinations. For example, while a particular type of information for a person (e.g., the person's billing address) from a particular type of source (e.g., cable television provider) may be highly reliable, different information from the same source may not be (e.g., the person's marital status). Furthermore, another source (e.g., person's social media page), may have reliable information for one type of information (e.g., the person's marital status), but not the other (e.g., the person's billing address).

Any of aforementioned criteria or scenarios could be incorporated into the structure and values associated with any particular data field or fields in the defined guidelines. Furthermore, any of aforementioned criteria or scenarios may be determined from data in the media content interests, source information and/or additional reliability metric guideline sources such as industry data, historical analysis, other user profiles, or observed behavior by a user or users.

Moreover, each reliability metric may be compared to a threshold reliability metric. As used herein, a threshold reliability metric is a value that indicates a minimum amount of reliability sufficient for media content interests from a source to be used to generate a user profile. For example, the profile clearinghouse application may determine that some information is too unreliable to include in the generation of the user profile; therefore, the information is excluded.

The amount of information available from the source or the amount of information available from all sources may also dictate how and what data will be returned to a given requester. For example, if a single source has only a minimal amount of information on the user's media content interests, the source may be disregarded in preference to a source that has more information on the user's media content interests. In some embodiments, the amount of data provided by a source may affect the value of the threshold reliability metric. For example, the threshold reliability metric may be high for a source that supplies only minimal information. In some embodiments, the amount of data provided by all the sources may affect the value of the threshold metric. For example, the threshold reliability metric may be high if there is an abundance of information for use in generating the user profile, whereas the threshold reliability metric may be low if there is not an abundance of information.

In some embodiments, where media content interests are provided by a plurality of sources, the media content interests for each source may be weighted when computing the user profile. For example, if a source is determined to have a low reliability (e.g., the reliability metric of the source is determined to be low), the media content interests of that source may have a low weight in the computation of the user profile. In contrast, if a source is determined to have a high reliability (e.g., the reliability metric of the source is determined to be high), the media content interests of that source may have a high weight in the computation of the user profile.

In some embodiments, the user profile may include all of the media content interests supplied by all of the sources. The user profile may also include an indication of the reliability (e.g., the reliability metric) of each source and/or an indication of the reliability of each media content interest. In some embodiments, the reliability metric may be scaled (e.g., the reliability metric may be expressed as a number one through one-hundred or expressed as a percentage of reliability).

In some embodiments, the profile clearinghouse application may determine or use other factors, which may be incorporated into the reliability metric or applied separately, to dictate what information may include the user profile. For example, the age of the information, whether or not it is indicated as reliable, may affect whether or not the information is provided. The type of information and the type of source may also affect whether or not the information is reliable. For example, although information on a particular device may not be determined to be reliable, industry standards may determine that media content interests from the particular device are the best indicator of the user's media content interests. Therefore, the media content interests of the particular device may be included in the user profile.

In some embodiments, the privacy settings of information on a source may indicate that a particular requester or group of requesters does not have access to the media content interests or source information of a particular source. In some embodiments, the profile clearinghouse application may use the non-accessible media content interests to generate verification information. As used herein, verification information is information used to verify the reliability of information (e.g., media content interests) in a user profile. The non-accessible media content interests are not included in the generated user profile, but the reliability derived using the verification data may be.

For example, accessible media content interests, which are included in the user profile, may be compared with non-accessible media content interests, which are not included in the user profile. After a comparison, the accessible media content interests may be determined to be more or less reliable. The newly generated reliability measurement may then be transmitted with the user profile, either in addition to previous reliability data (e.g., the reliability data generated without the verifying information) or in replacement of previous reliability data.

As referred to herein, the terms “media asset” and “media content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media profiling may be available on these devices as well. The profile provided may be for content available only through a television, for content available only through one or more of other types of user equipment devices, or for content available both through a television and one or more of the other types of user equipment devices.

The profile clearinghouse application may be provided as an on-line application (i.e., provided on a website), or as stand-alone application on a profile clearinghouse server or as a client on user equipment devices. Various devices and platforms that may implement the profile clearinghouse application are described in more detail below.

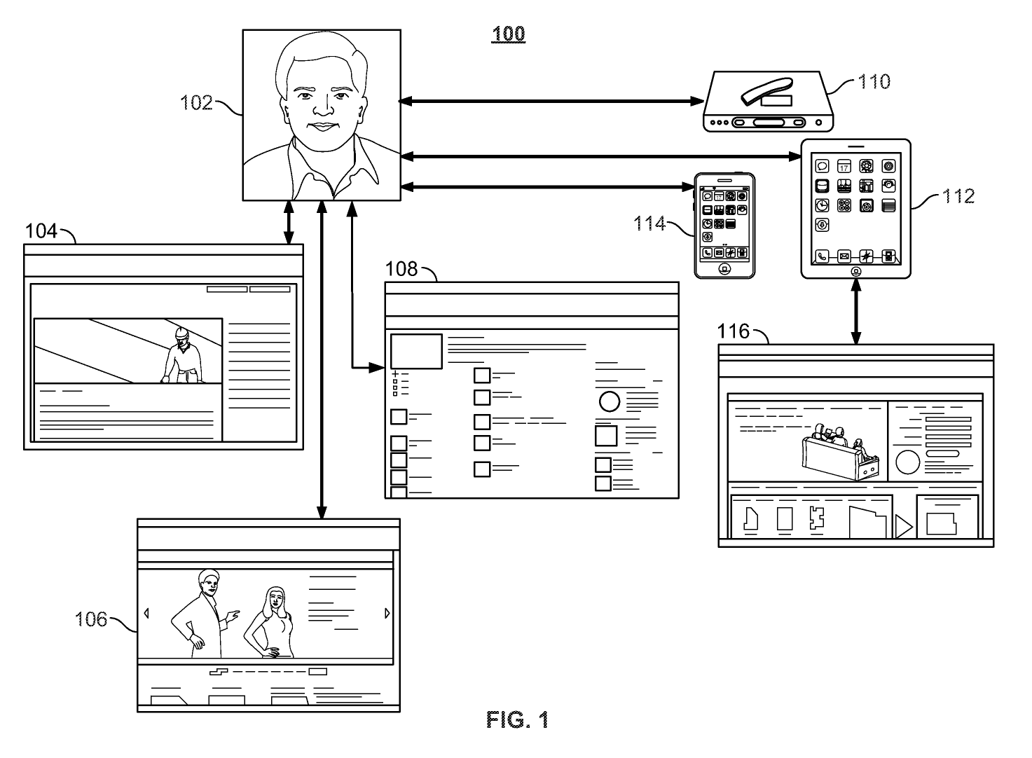

FIG. 1 shows an illustrative system that shows the sources used to generate a user profile in accordance with some embodiments of this disclosure. In system 100, profile 102 is a combination of the information on the user's media content interests available from the multiple sources (e.g., website services 104, 106, 108, and 116, and user devices 110, 112, and 114) filtered and retrievable according to privacy settings and reliability metrics.

The website services 104, 106, 108 and 116 shown in FIG. 1 may be implemented on any suitable user equipment device or platform (e.g., webpages accessed by a computer) and each represent a source. User devices 110, 112 and 114 may represent any type of user equipment device or platform, and each represents a source. Website service 116 represents a website account linked to a particular device, which may or may not be linked to a specific user.

In system 100, website services 104, 106, 108, and 116 and user devices 110, 112, and 114 are all related to a single user and may be used to generate a user profile 102. Website services 104, 106, 108, and 116 and user devices 110, 112, and 114 represent devices, entities or services that a user may have used, owned, or interacted with. Each of website services 104, 106, 108, and 116 and user devices 110, 112, and 114 may be sources, which monitor activities performed at the source. The monitored activity may be used to compile media content interests about the user.

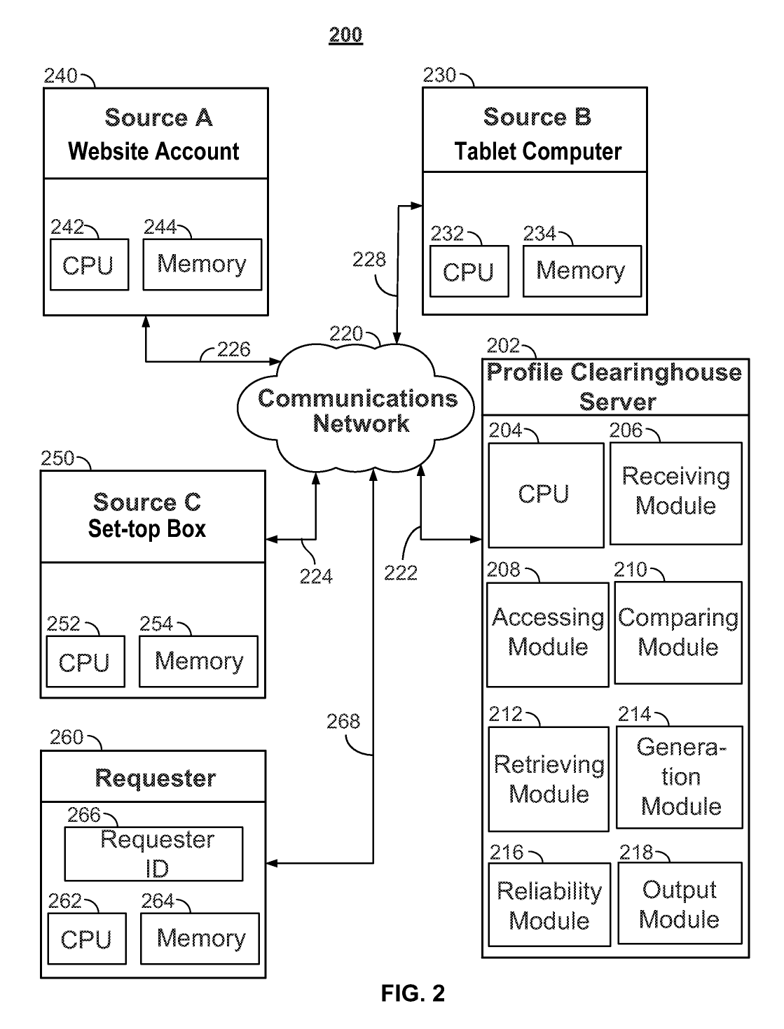

User profile 102 may be located at a profile clearinghouse server (e.g., profile clearinghouse server 202 (FIG. 2). In some embodiments, the profile clearinghouse server may determine which sources relate to a particular user. For example, the profile clearinghouse server may compare the source information and/or media content interests to determine the particular user. This may involve analyzing data fields in databases of each of the sources for similarities and indicators of a particular user. Alternatively, in some embodiments, each source may identify the user and transmit that information to the profile clearinghouse server. For example, each source may include a log of the user activity and transmit that log to the profile clearinghouse server.

A user may indicate a desire to access content by selecting a selectable option provided in any of website services 104, 106, 108, and 116 (e.g., a menu option, a listings option, an icon, a hyperlink, etc.) or pressing a dedicated button (e.g., a GUIDE button) or other user input interface or device. The source may record or monitor the user's action in relation to the display screen. The actions monitored may relate to the time, channel, source, content type, or category (e.g., movies, sports, news, children, or other categories of programming), selected by the user.

In addition to monitoring access to linear programming (e.g., content that is scheduled to be transmitted to a plurality of user equipment devices at a predetermined time and is provided according to a schedule), the sources may also monitor access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Website services 104, 106, 108, and 116 may provide organization and access to non-linear programming including on-demand listings, recorded content listings, and Internet content listings. A display combining organization and access to content from different types of content sources is sometimes referred to as a “mixed-media” display. Various permutations of the types of organization to media content may be displayed and may be based on user selection or input (e.g., a display of only recorded and broadcast listings, only on-demand and broadcast listings, etc.). Through website services 104, 106, 108, and 116 a user may have access to media content that may be displayed in response to the user selecting one of the navigational icons, all of which may be monitored by the source. For example, pressing an arrow key on a user input device may affect the website services 104, 106, 108, and 116 in a similar manner as selecting navigational icons.

Website services 104, 106, 108, and 116 may also provide an advertisement for content that, depending on a viewer's access rights (e.g., for subscription programming), is currently available for viewing, will be available for viewing in the future, or may never become available for viewing, and may correspond to or be unrelated to one or more of the content listings shown in website services 104, 106, 108, and 116. Advertisements may also be for products or services related or unrelated to the content displayed in website services 104, 106, 108, and 116. Advertisement may be selectable and provide further information about content, provide information about a product or a service, enable purchasing of content, a product, or a service, provide content relating to the advertisement, etc, which may be monitored by the source. Advertisements may be targeted based on a user's profile/preferences, monitored user activity, the type of display provided, or on other suitable targeted advertisement bases.

Media content interests may also include information related to media content advertisements. In addition, the source may monitor media content that was watched, not watched, advertised but not watched, watched but not advertised, episodes in a series that were watched, or episodes in a series that were not watched. In the case of PPV or on-demand media content, the source may monitor content that was purchased individually, content that was not purchased individually, content that was purchased with particular other media content, content that was not purchased with particular other media content, or any other feasible method or combination of multiple methods.

The website services 104, 106, 108, and 116 and user devices 110, 112, 114 may each include a personalized media guidance application that personalizes content, settings, or formatting based on a user's preferences, which may be monitored by the source. A personalized media guidance application allows a user to customize displays and features to create a personalized “experience” with the media guidance application. Users may access their personalized guidance application by logging in or otherwise identifying themselves to the guidance application. Customization of the media guidance application may be made in accordance with media content interests. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations, any of which may be monitored by the source.

The media guidance application on a source may allow the source to automatically compile information on a user's media content interests. The media guidance application may, for example, monitor the content the user accesses and/or other interactions the user may have with the guidance application. Additionally, the media guidance application may obtain all or part of other user media content interests that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access (e.g., user devices 110, 112, 114).

For example, a request from a company's internal service may be made for all the information in company's database about an employee. The privacy settings of the company's database indicate that the company's internal service is allowed to access all the information in the company's database. The information in the database may have come from several sources, including the employee (e.g., information from an employment application). In this example, the company is not only a requester and a source, but the company may also administer the profile clearinghouse application. The profile clearinghouse application may also be used to augment and enhance the information about the employee in the company's database.

To do so, the profile clearinghouse determines whether or not additional information on the employee is available from other sources, which may or may not be owned by the company. As the additional sources are not owned by the company, the company's internal service may not have access to the information on the employee from those sources. In addition, the company's internal service may not be able to determine the reliability of the information. Therefore, the company's internal service uses the profile clearinghouse application to interpret the privacy settings of the information of each source as well as determine the reliability of the information from each source. After doing so, the profile clearinghouse application may transmit a user profile containing information about the employee, which includes the information found in the company's database and information accessible from other sources.

In another example, a user may have purchased several items from a company's website. The company monitors and records this information and owns the rights to share, or withhold, the information from any requester. The company may want additional information on the user however. Therefore, the company then uses the profile clearinghouse application, which may or may not be owned by the company, to find additional sources of information.

The profile clearinghouse application determines with an eighty-five percent reliability that an account on a social media website belongs to the user. The profile clearinghouse application may do so by comparing information on the user to information from the social media webpage for consistency. The profile clearinghouse may also determine, based on a reliability metric, that the information available from the social media webpage is, with seventy percent reliability, indicative of the media content interests of the user. However, the social media webpage may restrict the information available to the company. The restriction may be based on contractual agreements between the social media webpage, the user, and/or other parties.

The profile clearinghouse application may also determine that a smartphone and tablet computer, registered with the company, belongs to the user. The smartphone and tablet computer may be further associated with a website service account. The profile clearinghouse application may, therefore, extract information from the website service account. In addition, the profile clearinghouse application may determine that at the address the user listed as his address in the company database, a set-top box is registered (e.g., the profile clearinghouse may have cross-referenced the user's information with information from a cable television provider).

For each of these sources, the profile clearinghouse application determines a reliability that the information from the source belongs to the user. The profile clearinghouse application may do so by comparing information on the user to information from the source. The profile clearinghouse may also determine, based on a reliability metric, that the reliability of the information available from each source. Finally, the profile clearinghouse application may interpret business rules (e.g., privacy settings and/or reliability metrics) for information on each source to determine whether or not to include information from the particular sources in a user profile delivered to the company. Moreover, if any of the information is not used in the user profile, some of the information may still be used to verify the information provided in the user profile.

FIG. 2 is a block diagram of an illustrative profile clearinghouse system in accordance with some embodiments of the disclosure. FIG. 2 shows profile clearinghouse server 202, source A 240, source B 230, source C 250, and requester 260 connected via communications network 220.

Methods and systems for providing a user profile can be implemented in system 200 of FIG. 2. For simplicity, source A 240, source B 230, and source C 250 may be referred to herein collectively as source equipment. Media content interests for one or more users may be stored at source A 240, source B 230, and source C 250 in respective memories 244, 234, 254, which may transmit media content interests using processors 242, 232, and 252, respectively. Specifically, processors 232, 242, 252, as well as processors 204 and 262 may receive and process requests for a user's media content interests or other information and provide information to profile clearinghouse server 202, requester 260, or any other source or device accessible via communications network 220. A profile clearinghouse server 202, on which a profile clearinghouse application may be implemented, may function as a standalone device or may be part of a network of devices. Various network configurations of devices may be implemented and are discussed in more detail below.

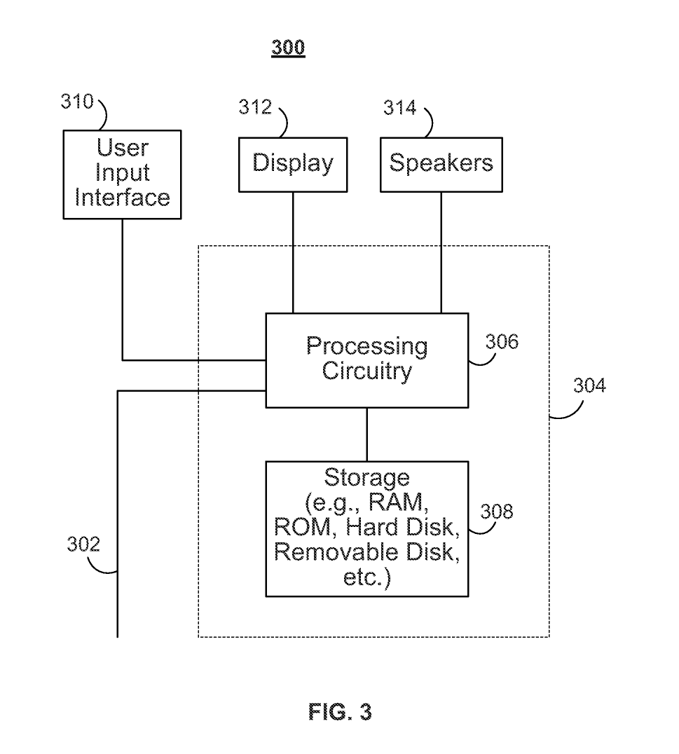

Source A 240, source B 230, and source C 250 may include at least some of the device components features described below in connection with FIG. 3. The sources may or may not be standalone devices or devices of the same type. For example, source A may be Internet-enabled allowing for access to Internet content, while sources B may include a tuner allowing for access to television programming. Furthermore, profile clearinghouse server 202, source A 240, source B 230, source C 250, and requester 260 may represent devices that are used to perform operations related to the functions of profile clearinghouse server 202, source A 240, source B 230, source C 250, and requester 260, respectively. For example, source A 240 may represent a website on which the user has an account. Source A includes a processor 242 and a memory 244. Likewise, Source B 230 could be a tablet computer or a remote storage device, including cloud storage as explained above. Finally, Source C 250 could be a set-top box or a central server used in operation with the set-top box.

In system 200, there may be more than three sources available, however, only three are shown in FIG. 2 to avoid overcomplicating the drawing. In some embodiments, source equipment may be a website account hosted on a particular source equipment (e.g., source A 240), a tablet computer (e.g., source B 230), or a set-top box (e.g., source C 250).

The source equipment may be coupled to communications network 220. Namely, source A 240, source B 230, and source C 250 are coupled to communications network 220 via communications paths 226, 228, and 224, respectively. Communications network 220 may be one or more networks including the Internet, a mobile phone network, mobile voice or data network (e.g., a 4G or LTE network), cable network, public switched telephone network, or other types of communications network or combinations of communications networks. Paths 226, 228, and 224 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the source equipment may be provided by one or more of these communications paths, but are shown as a single path in FIG. 2 to avoid overcomplicating the drawing.

Although communications paths are not drawn between the source equipment, these devices may communicate directly with each other via communication paths, such as those described above in connection with paths 226, 228, and 224, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The requester 260, profile clearinghouse server 202 may also communicate with each other, or the source equipment, directly through an indirect path via communications network 220.

System 200 also includes profile clearinghouse server 202 coupled to communications network 220 via communication path 222. Path 222 may include any of the communication paths described above in connection with communication paths 226, 228, and 224. Communications with the profile clearinghouse server 202 and source A 240, source B 230 and source C 250 may be exchanged over one or more communications paths, but are shown as a single path in FIG. 2 to avoid overcomplicating the drawing. In addition, there may be more than one profile clearinghouse server 202, but only one is shown in FIG. 2 to avoid overcomplicating the drawing.

If desired, profile clearinghouse server 202, source A 240, source B 230 and source C 250 may be integrated as one device. Although the connection of profile clearinghouse server 202, source A 240, source B 230, and source C 250 are shown through communications network 220, in some embodiments, profile clearinghouse server 202 may communicate directly with source A 240, source B 230 and source C 250 via other communication paths (not shown).

Source A 240, source B 230 and/or source C 250 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Source A 240, source B 230 and/or source C 250 may be the originator of content (e.g., a television broadcaster, a Webcast provider, etc.) or may not be the originator of content (e.g., an on-demand content provider, an Internet provider of content of broadcast programs for downloading, etc.). Source A 240, source B 230 and/or source C 250 may include cable sources, satellite providers, on-demand providers, Internet providers, over-the-top content providers, or other providers of content. Source A 240, source B 230 and/or source C 250 may also include a remote media server used to store different types of content (including video content selected by a user), in a location remote from any of the source equipment. Systems and methods for remote storage of content, and providing remotely stored content to source equipment are discussed in greater detail in connection with Ellis et al., U.S. Pat. No. 7,761,892, issued Jul. 20, 2010, which is hereby incorporated by reference herein in its entirety.

Profile clearinghouse server 202 may provide user profiles, such as a user profile to requestor 260 via communications path 268. A user profile, or media content interests, may be received by the requester using any suitable approach. In some embodiments, profile clearinghouse server 202 may be a stand-alone server that receives media content interests from source A, source B, and source C as well as requests from requester 260 via a data feed (e.g., a continuous feed or trickle feed).

In some embodiments, requester 260 may be configured to transmit a query (e.g., to the profile clearinghouse server 202) for a user profile, in which the query includes a requester identifier 266. Requestor 260 may transmit the query using processor 262 and memory 264. The profile clearinghouse server 202 may be configured to receive a plurality of data packets including media content interests from each of source A 240, source B 230, and source C 250 in response to the query. The profile clearinghouse server 202 may issue requests to source A 240, source B 230, and source C 250 in turn for the media content interests. The profile clearinghouse server 202 may be configured to generate a user profile, using control circuitry, and transmit the user profile to requester 260 in similar, or different, data packets, or in any type of data structure.

In some embodiments, processor 204 may be used to receive and process requests from requester 260. Furthermore, processor 204 may incorporate numerous modules (e.g., receiving module 206, accessing module 208, comparing module 210, retrieving module 212, generation module 214, reliability module 216 and output module 218) for performing various functions, which are shown separately for clarity, but which may be implemented using one or more processors or other control circuitry, or which may be implemented as software executable by one or more processors. Processor 204 may also store the information retrieved from various sources (e.g., source A 240, source B 230, and/or source C 250).

Receiving module 206 may be configured to receive a query from a requester 260 for a user profile including a user's media content interests, and data packets including a requester identifier. Accessing module 208 may be configured to access a data structure (e.g., source A 240) of a source, which includes media content interests and, in some cases, a privacy setting. Comparing module 210 may compare the data packets from the requester to the privacy setting of the information on the source to determine whether the requester 260 has access to at least some of the data from the first source. Retrieving module 212 may be configured to retrieve the media content interests from the data structure of the first source in response to the comparing module 210 determining the requester 260 has access to the first source. Generation module 214 may be configured to generate a first reliability metric from the first source, in which the first reliability metric indicates a likelihood that the first media content interests are indicative of the user's media content interests. Reliability module 216 may be configured to compare the first reliability metric to a reliability metric threshold. Output module 218 may be configured to generate the user profile for transmission to the requester 260 based at least in part on the media content interests received from the first source in response to determining the reliability metric exceeds the reliability metric threshold.

In addition, profile clearinghouse server 202, source A 240, source B 230, and source C 250 may include data structures (e.g., ordered/unordered flat files, hash tables, B+ trees, ISAM, and/or heaps) for storing the user profile data, media content interests, profile data, advertisement data and/or behavioral observations data. In addition, Profile clearinghouse server 202, source A 240, source B 230, and source C 250 may use any database management system and any standard encoding (e.g., ASCII, JPEG, MPEG-4).

In some embodiments, profile clearinghouse server 202 may be configured to receive a request for a user profile from requester 260. The profile clearinghouse server 202 may be configured to determine the type of data request based on the received transmission from requester 260. In addition, profile clearinghouse server 202 may be configured to process the data request and retrieve data. The retrieved data may be transmitted in data packets and may correspond to particular data fields. Furthermore, the profile clearinghouse server 202 may be configured to identify sections of data (e.g., header, payloads, etc.), flags or identifiers (e.g., indicating attributes about the data), as well as requested media content interests.

In some embodiments, profile clearinghouse server 202 may receive information from the source equipment using a client-server approach. For example, profile clearinghouse server 202 may pull media content interests and source information from the source equipment. In some embodiments, profile clearinghouse server 202 may initiate sessions when the media content interests or source information is out of date or when the profile clearinghouse server 202 receives a request from the requester 260. Media content interests and source information may be provided to the profile clearinghouse server 202 with any suitable frequency (e.g., continuously, daily, a system-specified period of time, in response to a request from requester 260, etc.). In addition, the profile clearinghouse application may provide itself, or source equipment, with software updates and may implement the processes of this disclosure as software or a set of executable instructions which may be stored in storage 308, and executed by control circuitry 304 of device 300 of FIG. 3, or any other device shown in FIGS. 1-4.

User profiles, media content interests or source information delivered to profile clearinghouse server 202, source A 240, source B 230, source C 250 or requester 260 may be over-the-top (OTT) content. OTT content delivery allows Internet-enabled devices, including set-top box source equipment as described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide user profiles, media content interests, source information, or media guidance as delivered described above.

Network system 200 is intended to illustrate a number of approaches, or network configurations. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, which provide cloud-based services to various types of users and devices connected via a network such as the Internet via communications network 220. These cloud resources may include one or more user profiles, media content interests or source information used by profile clearinghouse server 202, source A 240, source B 230, source C 250 or requester 260. In addition, the profile clearinghouse server 202 may be implemented in the cloud.

The cloud provides access to services, such as content storage, content sharing, or social networking services, among other examples, as well as access to any content described above, for devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow source equipment or the profile clearinghouse server 202 to store content to the cloud and to receive content from the cloud rather than storing content locally and accessing locally-stored content.

A system may use various content capture devices, such as camcorders, digital cameras with video mode, audio recorders, mobile phones, and handheld computing devices, to record content any of which may function as a source. The system can upload content to a content storage service on the cloud either directly, for example, from source equipment having content capture feature. Alternatively, the system can first transfer the content to source equipment, such as a tablet computer (e.g., source B 230). In some embodiments, the source equipment itself is a cloud resource, and other devices such as other source equipment or the profile clearinghouse server 202 can access the content directly from the device on which the system stored the content.

Cloud resources may be accessed by source equipment, for example, a web browser, a media guidance application, a desktop application, a mobile application, and/or any combination of access applications of the same. The source equipment may be a cloud client that relies on cloud computing for application delivery, or the source equipment may have some functionality without access to cloud resources. For example, some applications running on the source equipment may be cloud applications, i.e., applications delivered as a service over the Internet, while other applications may be stored and run on the source equipment. In some embodiments, source equipment or profile clearinghouse server 202 may receive content from multiple cloud resources simultaneously. In some embodiments, user equipment devices can use cloud resources for processing operations such as the processing operations performed by processing circuitry described in relation to FIG. 3.

FIG. 3 shows a generalized embodiment of illustrative device 300. Device 300 may implement any source equipment, profile clearinghouse server 202 (FIG. 2), requester 260 (FIG. 2), or any other device in FIGS. 1-2 and 4. More specific implementations of devices are discussed below in connection with FIG. 2. Device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a user profiles, media content interests, source information and/or requests stored in memory (i.e., storage 308). Specifically, control circuitry 304 may be instructed to perform the functions discussed above and below.

In client-server based embodiments, control circuitry 304 may include communications circuitry suitable for communicating with other devices accessible via communications network 220. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 2). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information described above and guidance application data described above. Nonvolatile memory may also be used (e.g., to launch a boot-up routine and other instructions). Cloud-based storage, described in relation to FIG. 2, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the device 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided separately from device 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of device 300 or may be stand-alone units. The audio component of videos and other content displayed on display 312 may be played through speakers 314. In some embodiments, the audio may be distributed to a receiver (not shown), which processes and outputs the audio via speakers 314.

The systems disclosed herein may be implemented using any suitable architecture. For example, it may be a stand-alone application wholly implemented on device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on device 300 is retrieved on-demand by issuing requests to a server remote to the device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

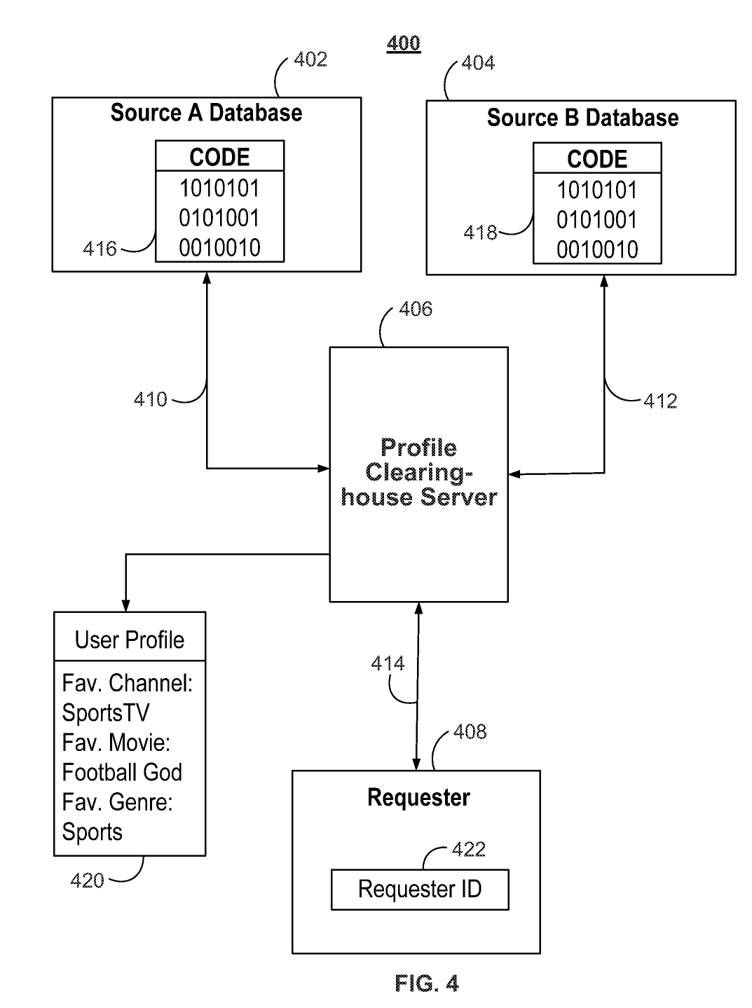

FIG. 4 is an illustrative diagram of a system including a profile clearinghouse application in accordance with some embodiments of the disclosure. FIG. 4 shows system 400. System 400 shows a high-level interpretation of the actions in some embodiments of this disclosure. The underlying operations involved in system 400 will be discussed in more detail below.

System 400 includes source A database 402, source B database 404, profile clearinghouse server 406, and requester 408. Source A database 402, source B database 404, profile clearinghouse server 406, and requester 408 are connected via connections 410, 412 and 414. The connections may be through the communications network 220 (FIG. 2) as discussed above.

In system 400, source A database 402 includes code 416, which includes privacy settings, source information, and media content interests (e.g., from source A 240 (FIG. 2)). Source B database 404 includes code 418, which includes privacy settings, source information, and media content interests (e.g., from source B 230 (FIG. 2)). In some embodiments, profile clearinghouse server 406 may use code 416 and code 418 to generate user profile 420, which is transmitted to the requester 408.

Using systems and methods described above and below, in some embodiments profile clearinghouse server 406 may receive a query from requester 408 for a user profile 420 including a user's media content interests, and a requester identifier (e.g., requester identifier 422). Profile clearinghouse server 406 may access a data structure (e.g., source A database 402) of a first source including first media content interests and a privacy setting (e.g., code 416). Profile clearinghouse server 406 may compare requester identifier 422 to the privacy setting (e.g., the privacy setting retrieved from code 416) to determine whether or not the requester 408 has access to the user media content interests on the first source (e.g., source A database 402).

In response to determining the requester 408 has access to the first source (e.g., source A database 402), profile clearinghouse server 406 may retrieve the first media content interests (e.g., the first media content interests from code 416) from the data structure (e.g., source A database 402) of the first source. Profile clearinghouse server 406 may generate a first reliability metric from the first source, in which the first reliability metric indicates a likelihood that the first media content interests are indicative of the user's media content interests. Profile clearinghouse server 406 may compare the first reliability metric to a reliability metric threshold and in response to determining the reliability metric exceeds the reliability metric threshold, profile clearinghouse server 406 may generate the user profile 420 for transmission to the requester 408 based at least in part on the first media content interests (e.g., the first media content interests from code 416).

In some embodiments, profile clearinghouse server 406 may access a data structure (e.g., source B database 404) of a second source including second media content interests and a second privacy setting (e.g., code 418). Profile clearinghouse server 406 may compare the data packets (e.g., data packets including the requester identifier 422) to the second privacy setting (e.g., the second privacy setting retrieved from code 418) to determine whether or not the requester 408 has access to the second media content interests of the second source (e.g., source B database 404).

In response to determining the requester 408 has access to the second source (e.g., source B database 404), as well as the first source (e.g., source A database 402), profile clearinghouse server 406 may retrieve the second media content interests (e.g., the second media content interests from code 418) from the data structure (e.g., source B database 404) of the second source. Profile clearinghouse server 406 may generate a second reliability metric from the second source, in which the second reliability metric indicates a likelihood that the second media content interests are indicative of the user's media content interests.

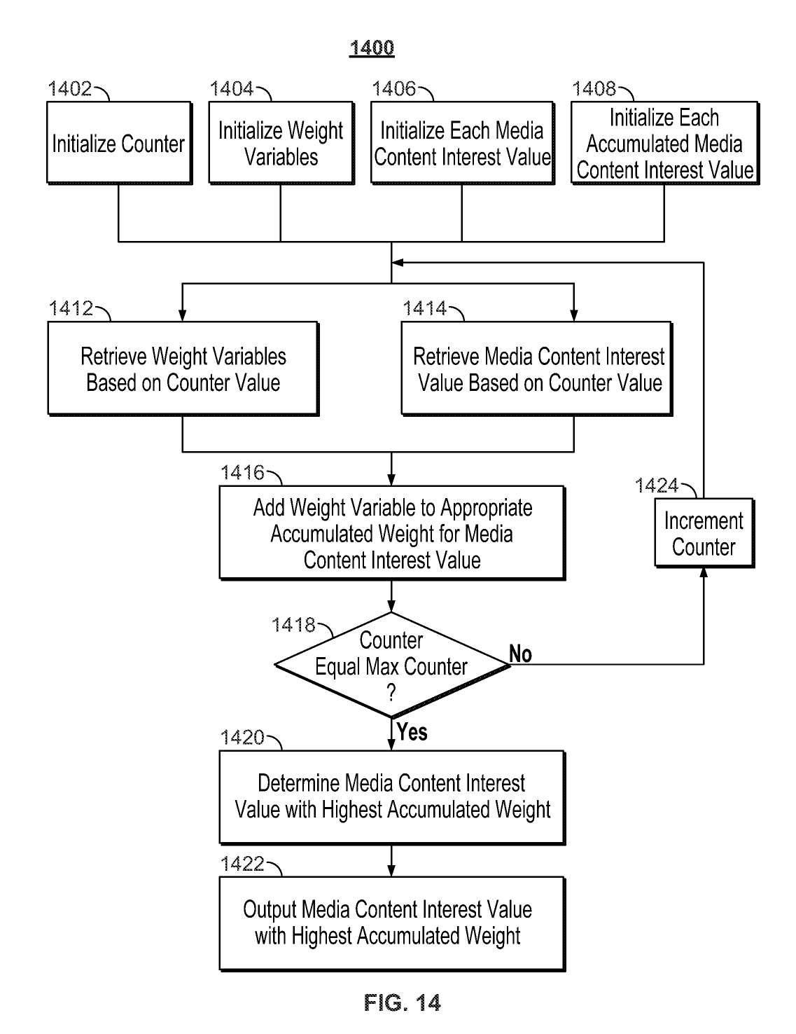

Profile clearinghouse server 406 may compare the second reliability metric to a reliability metric threshold and in response to determining the reliability metric exceeds the reliability metric threshold, profile clearinghouse server 406 may generate the user profile 420 for transmission to the requester 408 based at least in part on the first media content interests (e.g., the first media content interests from code 416) and the second media content interests (e.g., the second media content interests from code 418). In some embodiments, as discussed in more depth in relation to FIG. 14, the first media content interests (e.g., the first media content interests from code 416) and the second media content interests (e.g., the second media content interests from code 418) may be compared and only the most reliable media content interests may be transmitted in the user profile 420 to requester 408.

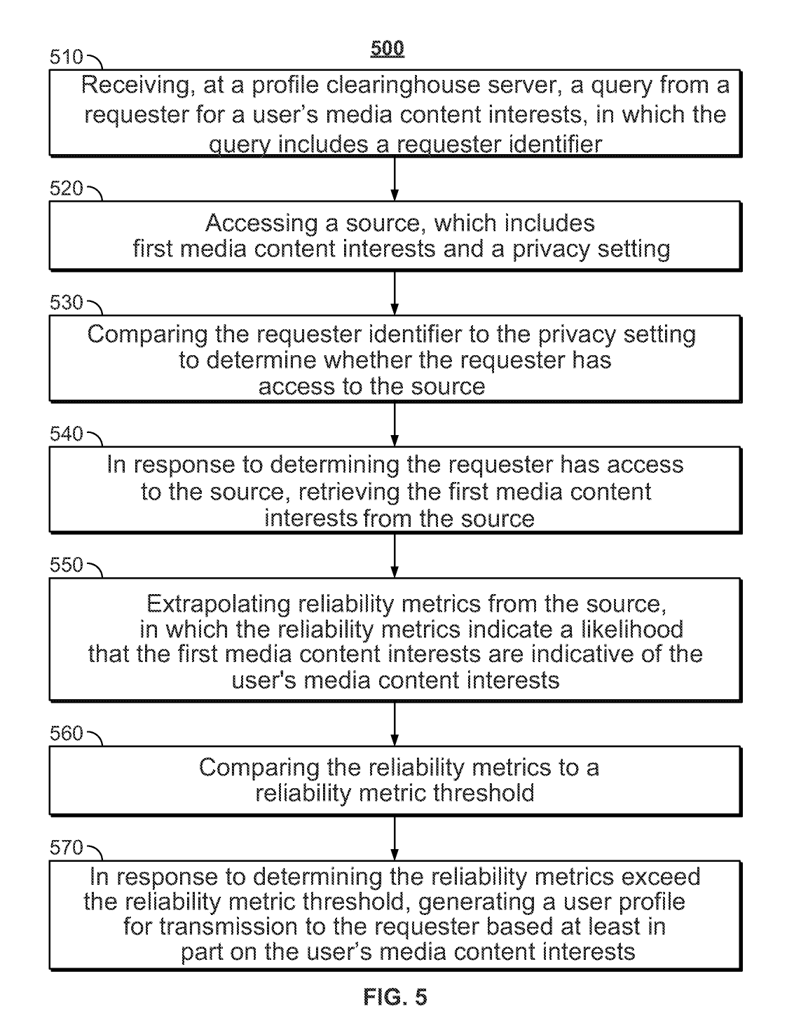

FIG. 5 is a flowchart of illustrative steps involved in providing a user profile in accordance with some embodiments of the disclosure. FIG. 5 shows process 500, which provides a user profile in response to a requestor's query.

At step 510, process 500 receives a query from a requester for a user profile including a user's media content interests, in which the query includes a requester identifier. The query may be transmitted in any suitable form as discussed in relation to FIG. 2. For example, the query may be transmitted in data packets, which are received and interpreted by profile clearinghouse server 202 (FIG. 2).

At step 520, process 500 accesses a source which includes first media content interests and a privacy setting. For example, profile clearinghouse server 202 may access source A 240 (FIG. 2). Source A may store the first user media content interests and the first user privacy setting on memory 244 (FIG. 2). Through an interaction with processor 242 (FIG. 2), profile clearinghouse server 202 (FIG. 2) may access this information.

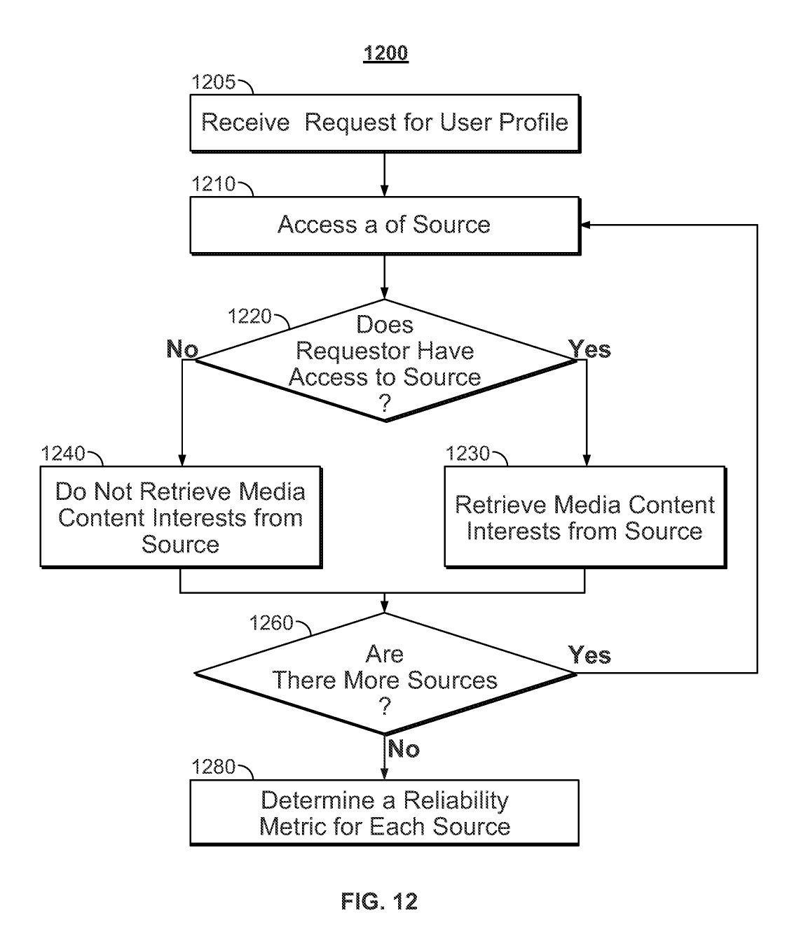

At step 530, process 500 compares the requester identifier to the privacy setting to determine whether the requester has access to the media content interests of the user on the source. For example, profile clearinghouse server 202 (FIG. 2) may interpret the privacy settings of the data within memory 244 (FIG. 2) of source A 240 (FIG. 2). In some embodiments, profile clearinghouse server 202 may retrieve the data before it interprets the data. In some embodiments, data in memory 244 (FIG. 2) such as source information and media content interests may be interpreted after transmission to profile clearinghouse server 202 (FIG. 2). Comparing privacy settings will be discussed in more depth in relation to FIG. 12 below.

At step 540, process 500 retrieves the first media content interests from the source in response to determining the requester has access to the source. For example, upon determining that requester 260 (FIG. 2) has access to the information, profile clearinghouse server 202 (FIG. 2) may pull the information from source A 240. The information may be sent via communications network 220 (FIG. 2).

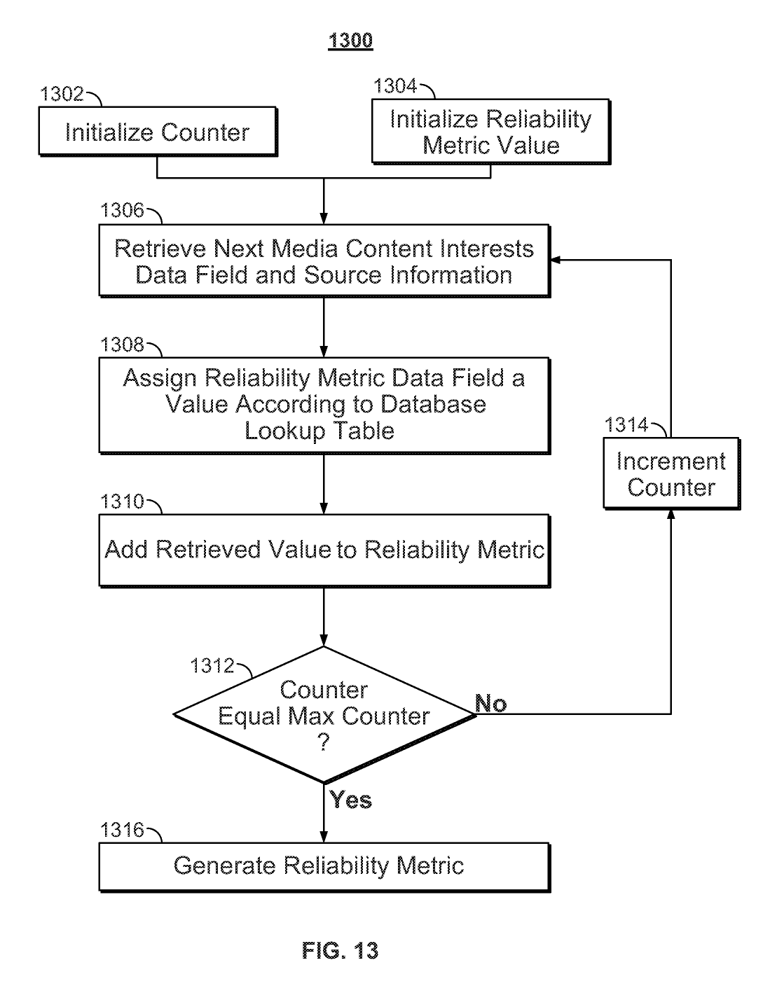

At step 550, process 500 generates reliability metrics from the source, in which the reliability metrics indicates a likelihood that the first media content interests are indicative of the user's media content interests. For example, using source information regarding source A 240 (FIG. 2), profile clearinghouse server 202 (FIG. 2) may determine reliability of the media content interests. Generating a reliability metric will be discussed in depth below in relation to FIG. 13.

At step 560, process 500 compares the reliability metrics to a reliability metric threshold. For example, profile clearinghouse server 202 (FIG. 2) may compare the reliability metric to a specific reliability metric threshold as will be discussed in depth below in relation to FIG. 13.

At step 570, process 500 generates the user profile for transmission to the requester based at least in part on the first media content interests in response to determining the reliability metrics exceed the reliability metric threshold. For example, profile clearinghouse server 202 (FIG. 2) may generate a user profile to send to requester 260 (FIG. 2) based on the media content interests. The process of generating a user profile will be discussed in more depth in relation to FIG. 14.

It should be noted that any of the devices or equipment discussed in relation to FIGS. 1-4 could be used to perform one of more of the steps in FIG. 5. It is also contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method.

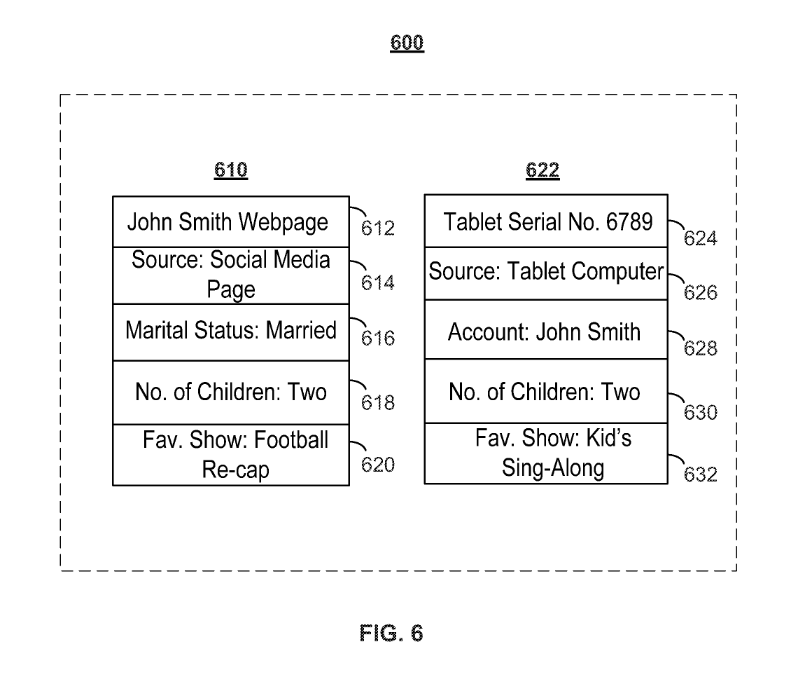

FIG. 6 is an illustrative diagram of the data structures of a plurality of sources in accordance with some embodiments of the disclosure. FIG. 6 shows two data structures 610 and 622 as retrieved and processed within profile clearinghouse application 600.

In FIG. 6, profile clearinghouse application 600 has retrieved (e.g., from source A database 402 (FIG. 4) and source B database 404 (FIG. 4)) and processed two data structures. For example, the two retrieved data structures may correspond to a website account (e.g., source A 240 (FIG. 2)) and a tablet computer (e.g., source B 230 (FIG. 2)). The data fields shown are exemplary and may include any suitable field, including a list of media assets, used to provide and/or describe a user's media content interests as described above.

Data structure 610 represents a data structure retrieved and processed from a webpage for a user. The data structure is organized in an array including data fields 612, 614, 616, 618 and 620. Data field 612 indicates that the data structure corresponds to a webpage for “John Smith.” Data field 614 indicates that the source is a social media page. Data field 616 indicates that the user is married. Data field 618 indicates the user has two children. Data field 620 indicates the favorite show of the user is “Football Re-cap.” For example, the information obtained by the source may come from inputs by the user onto the webpage, during a credit card transaction, or general billing information. In another example, data structure 610 may represent information received from website services 104, 106, and 108 (FIG. 1) such as a customer account associated with a webpage.

In some embodiments, profile clearinghouse application 600 may use source information or known media content interests about the user to ensure that the information retrieved from the source is in fact associated with the user (as opposed to another person with the same name). In this way, profile clearinghouse application 600 may determine that two media content interests from two different sources are related. In some embodiments, the source may determine that the media content interests provided by the source are related to the user.

Data structure 622 represents a data structure retrieved from a tablet computer registered to the user. The data structure is organized in an array including data fields 624, 626, 628, 630 and 632. Data field 624 indicates the serial number of the tablet computer. Data field 626 indicates the source is a tablet computer. Data field 628 indicates that the tablet computer is owned or registered to an account for “John Smith.” Data field 630 indicates that the user has two children, and data field 632 indicates the user's favorite show is “Kid's Sing-A-Long.” The media content interests (e.g., the favorite show of the user) may be monitored by the device as described in relation to FIG. 1. The device may be used to view programming, and the show “Kids' Sing-Along” may be the most frequently watched show. In some embodiments, the media content interests accessed through a device may relate to another third party source. For example, data structure 622 may correspond to user device 112. User device may have a streaming media website account associated with that device. User device 112 may monitor the shows that are watched on user device 112 to develop the media content interests that are provided to the profile clearinghouse application 600.

It should be noted that any of the devices or equipment discussed in relation to FIGS. 1-4 could be used to house the profile clearinghouse application 600, data structure 602, and/or data structure 622. It is also contemplated that the profile clearinghouse application 600, data structure 602, and/or data structure 622 of FIG. 6 may be used with any other embodiment of this disclosure. In addition, the data fields may appear or be arranged in alternative orders or in parallel to further the purposes of this disclosure.

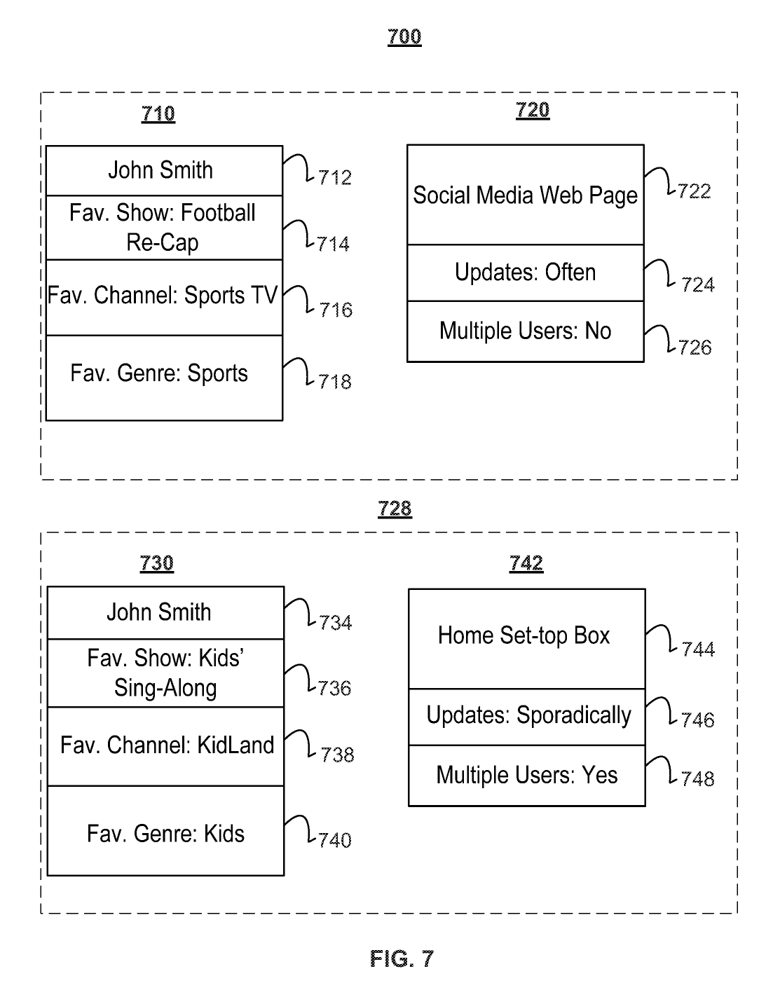

FIG. 7 is an illustrative diagram of the media content interests and source information data structure in accordance with some embodiments of the disclosure. The data fields shown are exemplary and may include any suitable field, including a list of media assets, used to provide and/or describe a user's media content interests as described above.

FIG. 7 shows data structure 700 retrieved from a source (e.g., source A 240 (FIG. 2)), which includes media content interests 710 and source information 720. The media content interests 710 show media content interests for “John Smith” as indicated by data field 712. Media content interests 710 indicate that the user's favorite show is “Football Re-Cap” at data field 716, the user's favorite channel is “Sports TV” at data field 716, and the user's favorite genre is “Sports” at data field 718. Source information 720 indicates that the source is a “Social Media Web Page” at data field 722, the media content interests are updated “Often” at data field 724, and there are not multiple users at data field 726.

FIG. 7 also shows data structure 728, which is retrieved from another source (e.g., source B 230 (FIG. 2)), which includes media content interests 730 and source information 742. Media content interest 730 shows media content interests for “John Smith” as indicated by data field 734. Media content interests 730 indicate that the user's favorite show is “Kid's Sing-Along” at data field 716, the user's favorite channel is “Kidland” at data field 716, and the user's favorite genre is “Kids” at data field 718. Source information 742 indicates that the source is a “Home Set-top Box” at data field 744, the media content interests are updated “Sporadically” at data field 746, and there are multiple users at data field 748.

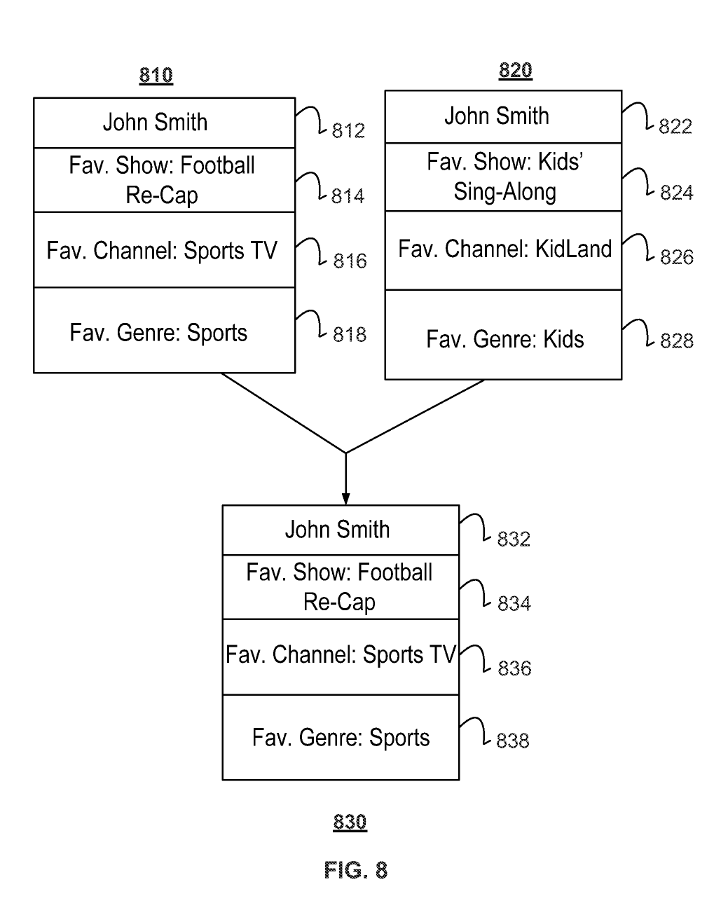

The media content interests 710 and 730 may be used to generate a user profile (e.g., user profile 420 (FIG. 4)). Source information 720 and 742 may be used to assign weights to media content interests 710 and 730 when generating a user profile as discussed in relation to FIG. 8. For example, source information 720 and 742 may be used to determine the reliability of media content interests 710 and 730, respectively. For example, source information 720 indicates that the user's social media webpage is not shared by multiple users. In contrast, source information 742 indicates that the user's home set-top box is shared by multiple users.

It should be noted that any of the devices or equipment discussed in relation to FIGS. 1-4 could be used to house data structure 700 and/or data structure 728. It is also contemplated that data structure 700 and/or data structure 728 of FIG. 7 may be used with any other embodiment of this disclosure. In addition, the data fields may appear or be arranged in alternative orders or in parallel to further the purposes of this disclosure.

FIG. 8 is an illustrative diagram of some embodiment of the disclosure comparing media content interests from two sources to determine a user profile. The data fields shown are exemplary and may include any suitable field, including a list of media assets, used to provide and/or describe a user's media content interests as described above.

FIG. 8 shows a data structure of media content interests 810 for the user as indicated by data field 812. Media content interests 810 corresponds to media content interests 710 (FIG. 7). Media content interests 820 are for the user as indicated by data field 822. Media content interests 820 corresponds to media contents interests 730 (FIG. 7). As shown in FIG. 8 media content interests 810 and media content interests 820 have conflicting information with respect to data fields 814, 816, and 818 of media content interests 810 and data fields 824, 826, and 828 of media content interests 820. The media content interests are compared to determine the information that will make up the media content interests in the user profile 830.

Based on the source information 720 (FIG. 7), (e.g., the source is a social media webpage, which is updated often and does not have multiple users) media content interests 810 is determined to be more reliable (e.g., the reliability metric is higher) than media content interests 820. For example, the source information 720 (FIG. 7) and 742 (FIG. 7) may have each been compared to a lookup table, which assigned a value to each data field of each of source information 720 (FIG. 7) and source information 742 (FIG. 7). By combining the assigned values, a reliability metric may have been generated for the media content interests 810 and media content interests 820. The reliability metric for media content interests 810 may have been higher than the reliability metric for media content interests 820. Therefore, the media content interests in the user profile 830 recite that for the user as indicated by data field 832, the favorite show is “Football Re-Cap” as shown in data field 834, the favorite channel is “Sports TV” as shown in data field 836, and the favorite genre is “Sports” as shown in data field 838.

It should be noted that any of the devices or equipment discussed in relation to FIGS. 1-4 could be used to house media content interests 810, media content interests 820, and/or user profile 830. It is also contemplated that media content interests 810, media content interests 820, and/or user profile 830 may be used with any other embodiment of this disclosure. In addition, the data fields may appear or be arranged in alternative orders or in parallel to further the purposes of this disclosure.

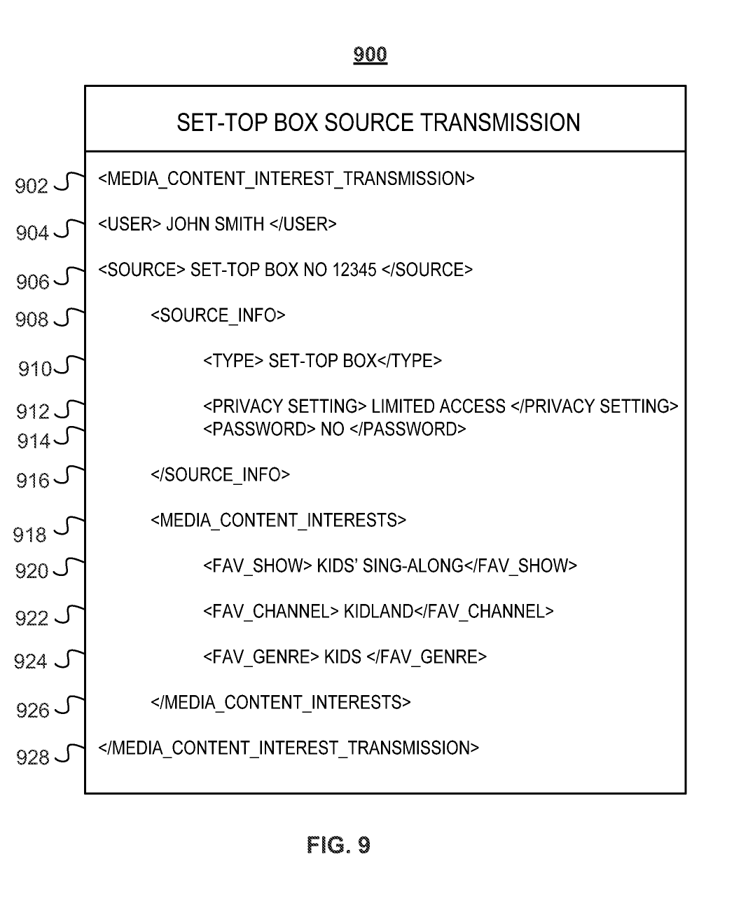

FIG. 9 shows an exemplary data structure for a transmission from a source in accordance with some embodiments of the disclosure. The lines of code used to describe the source information and media content interests shown are exemplary and may include any suitable code, including code listing media assets, used to provide and/or describe the source information and a user's media content interests as described above. FIG. 9 shows a data structure 900 as transmitted from a source (e.g., source A database 402 (FIG. 4)) in some embodiments of the disclosure. For example, FIG. 9 may display the data structure of media content interests and source information as transmitted from source C 250 (FIG. 2) to the profile clearinghouse server 202 (FIG. 2).

Line 902 of data structure 900 indicates that the transmission is a media content transmission. For example, this line may indicate that the transmission from the source (e.g., source A database 402) is in regards to media content interests. Line 904 indicates that the user is “John Smith.” For example, this line may indicate that the transmission from the source (e.g., source A database 402) is in regards to media content interests about the user. Line 906 indicates that the name of the source, specifically, “Set-top Box No. 12345.” For example, this line may indicate that the transmission from the source (e.g., source A database 402) is in regards to media content interests about the user on a particular device. Line 908 indicates the beginning of source information. Line 910 indicates that the type of source is a set-top box. Line 912 indicates that the privacy settings for information on the source. In this example, the privacy settings grant only limited access to the media content interests, which may restrict the information that may be transmitted to a requester from this source. Line 914 indicates that there is no password associated with the source. Line 916 indicates the end of the source information. In some embodiments, the source information may be used to determine the reliability metric (e.g., as in step 550 (FIG. 5)). The source information listed in FIG. 9 is exemplary only and additional or alternative source information as described throughout this disclosure may be transmitted.

Line 918 indicates the beginning of the media content interests. Line 920 indicates that the user's favorite show is “Kids' Sing-Along.” Line 922 indicates the user's favorite channel is “KidLand.” Line 924 indicates that the user's favorite genre is “Kids.” Line 926 indicates the end of the media content interests, and line 928 indicates the end of the transmission. The media content interests may be used to develop a user profile (e.g., the user profile 420 (FIG. 4). The media content interests listed in FIG. 9 are exemplary only and additional or alternative media content interests as described throughout this disclosure may be transmitted.

It should be noted that any of the devices or equipment discussed in relation to FIGS. 1-4 could be used to send, receive, or interpret the data structure 900 FIG. 9. It is also contemplated that the data structure 900 may be used with any other embodiment of this disclosure.

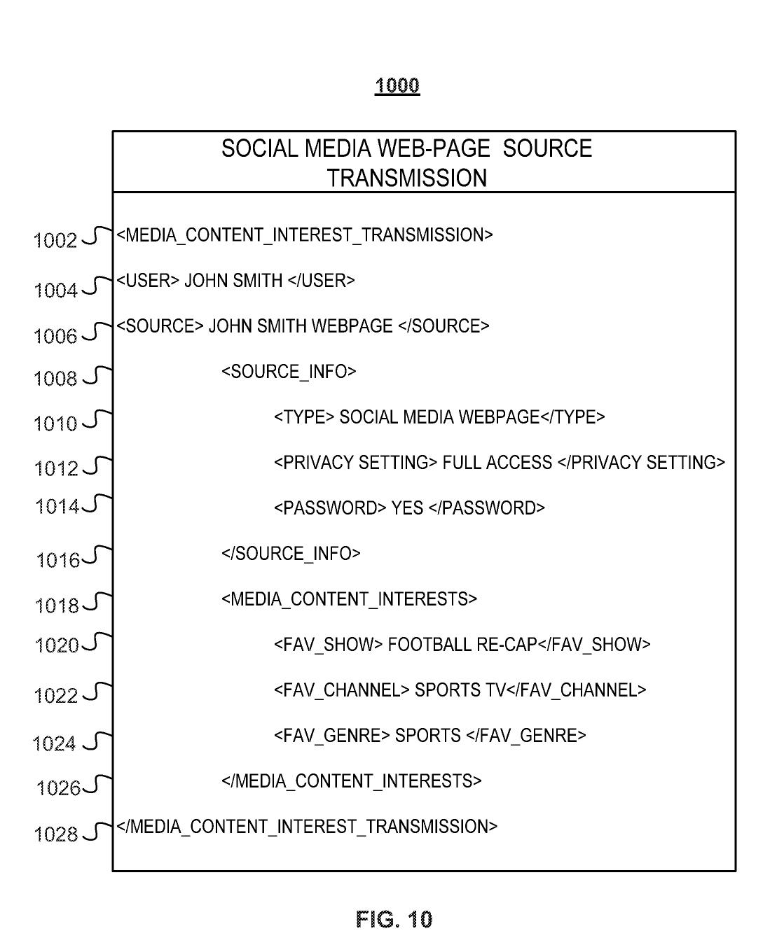

FIG. 10 shows an exemplary data structure for a transmission from a source (e.g., source B database 404 (FIG. 4)) in accordance with some embodiments of the disclosure. The lines of code used to describe the source information and media content interests shown are exemplary and may include any suitable code, including code listing media assets, used to provide and/or describe the source information and a user's media content interests as described above. FIG. 10 shows a data structure 1000 as transmitted from a source in some embodiments of the disclosure. For example, FIG. 10 may display the data structure of media content interests and source information as transmitted from source A 240 (FIG. 2) to the profile clearinghouse server 202 (FIG. 2).

Line 1002 of data structure 1000 indicates that the transmission is a media content transmission. For example, this line may indicate that the transmission from the source (e.g., source B database 404) is in regards to media content interests. Line 1004 indicates that the user is “John Smith.” For example, this line may indicate that the transmission from the source (e.g., source B database 404) is in regards to media content interests about the user. Line 1006 indicates that the name of the source, specifically, “John Smith Webpage.” For example, this line may indicate that the transmission from the source (e.g., source B database 404) is in regards to media content interests about the user and from a webpage.

Line 1008 indicates the beginning of source information. Line 1010 indicates that the type of source is a social media webpage. Line 1012 indicates that the privacy settings for the information about the user on the source. Line 1014 indicates that there is a password associated with the source. Line 1016 indicates the end of the source information. In some embodiments, the source information may be used to determine the reliability metric (e.g., as in step 550 (FIG. 5)). The source information listed in FIG. 10 is exemplary only and additional or alternative source information as described throughout this disclosure may be transmitted.

Line 1018 indicates the beginning of the media content interests. Line 1020 indicates that the user's favorite show is “Football Re-cap.” Line 1022 indicates the user's favorite channel is “Talk Sports.” Line 1024 indicates that the user's favorite genre is “Sports.” Line 1026 indicates the end of the media content interests, and line 1028 indicates the end of the transmission. The media content interests may be used to develop a user profile (e.g., the user profile 420 (FIG. 4). The media content interests listed in FIG. 10 are exemplary only and additional or alternative media content interests as described throughout this disclosure may be transmitted.

It should be noted that any of the devices or equipment discussed in relation to FIGS. 1-4 could be used to send, receive, or interpret the data structure 1000 FIG. 10. It is also contemplated that the data structure 1000 may be used with any other embodiment of this disclosure.

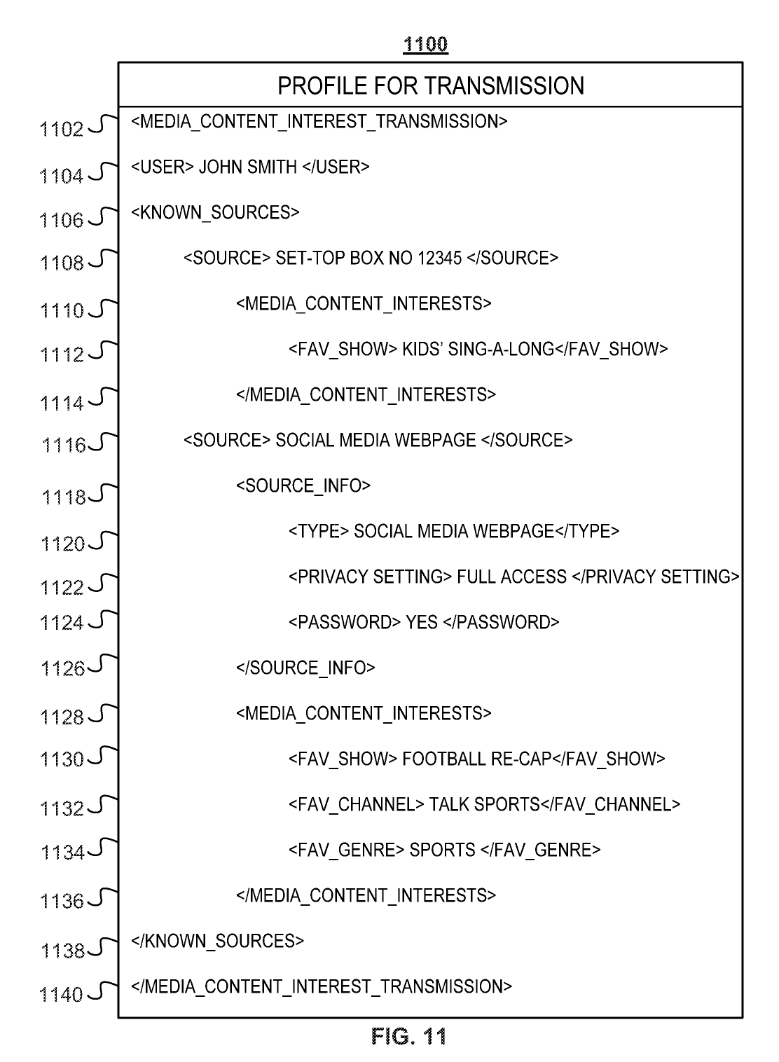

FIG. 11 shows an exemplary data structure for a profile for transmission from the profile clearinghouse server 202 (FIG. 2) in accordance with some embodiments of the disclosure. For example, using data structure 900 (FIG. 9) and data structure 1000 (FIG. 10), a profile for transmission may be generated (e.g., by profile clearinghouse server 202 (FIG. 2)). Data structure 1100 retrieves and processes data structure 900 (FIG. 9) and data structure 1000 (FIG. 10). The lines of code used to describe the source information and media content interests shown are exemplary and may include any suitable code, including code listing media assets, used to provide and/or describe the source information and a user's media content interests as described above.

At line 1102, data structure 1100 indicates that the data structure 1100 is for a media content interest transmission. For example, this line may indicate that the transmission from the profile clearinghouse server (e.g., profile clearinghouse server 406 FIG. 4)) is in regards to a user profile (e.g., user profile 420 (FIG. 4)). Line 1104 indicates that the user is “John Smith.” For example, this line may indicate that the transmission from the profile clearinghouse server (e.g., profile clearinghouse server 406 FIG. 4)) is in regards to a user profile (e.g., user profile 420 (FIG. 4)) for a user named “John Smith.” Line 1106 the known sources of the profile, specifically, data structure 900 (FIG. 9) and data structure 1000 (FIG. 10). For example, this line may indicate that the user profile (e.g., user profile 420 (FIG. 4)) is based on data structure 900 (FIG. 9) (e.g., source A database 402 (FIG. 4)) and data structure 1000 (FIG. 10) (e.g., source B database 404 (FIG. 4)).

Line 1108 indicates the first source is a set-top box. Line 1110 indicates the media content interests that were provided by data structure 900 (FIG.). At line 1112, data structure 1100 only lists the favorite show according to data structure 900 (FIG. 9). A shown in line 912 (FIG. 9), the source of data structure 900 granted limited access to the media content interests. In this case, the result is only the favorite show from the media content interests of data structure 900 is transmitted with the data structure 1100 of the user profile.

Line 1114 indicates the end of the media content interests from data structure 900 (FIG. 9). Line 1016 indicates that the type of source is a social media webpage. Line 1118 indicates the beginning of source information. Line 1020 indicates that the type of source is a social media webpage. Line 1122 indicates that the privacy settings for the information on the source. In this case, data structure 1000 (FIG. 10) granted “full access” to the requester; therefore, more information from data structure 1000 (FIG. 10) is provided in data structure 1100 of the user profile than was provided by data structure 900, which granted limited access to the media content interests.

Line 1124 indicates that there is a password associated with the source. Line 1126 indicates the end of the source information. Line 1128 indicates the beginning of the media content interests. Line 1130 indicates that the user's favorite show is “Football Re-cap.” Line 1132 indicates the user's favorite channel is “Talk Sports.” Line 1134 indicates that the user's favorite genre is “Sports.” Line 1136 indicates the end of the media content interests, and line 1138 indicates the end of the known sources. Finally, line 1140 indicates the end of the media content interest transmission.

It should be noted that any of the devices or equipment discussed in relation to FIGS. 1-4 could be used to send, receive, or interpret the data structure 1100 FIG. 11. It is also contemplated that the data structure 1100 may be used with any other embodiment of this disclosure.

FIG. 12 is a flowchart of illustrative steps involved in interpreting the privacy settings for information on a user located at a source to determine the amount of sources that may contribute to a user profile in accordance with some embodiments of the disclosure. In some embodiments, FIG. 12 may be a more detailed description of step 530 (FIG. 5).

FIG. 12 shows process 1200. At step 1205, process 1200 receives a request for a user profile. In some embodiments, the request may have come from a requester 260 (FIG. 2), and the profile clearinghouse server 202 (FIG. 2) may have received the request. In some embodiments, the request includes a requester identifier 266 (FIG. 2).

At step 1210, process 1200 accesses a of source. The source may correspond to source A 240, source B 230, source C 250 (FIG. 2), website services 104, 106, 108, 116 (FIG. 1), or user devices 110, 112, 114 (FIG. 1). At step 1220, process 1200 determines whether or not the requester 260 (FIG. 2) has access to a given source. To determine this process 1200 may review the privacy settings of the media content interests of the user on the particular source. The privacy settings may dictate which people, entities or services may access any given data. The process 1200 compares the privacy settings with the requester identifier supplied by the requester. If the requester is determined to have access, the media content interests from the source will be retrieved at step 1230. If the requester 260 (FIG. 2) is determined not to have access, the process 1200 does not retrieve the media content interests from the source at step 1240.

At step 1260, process 1200 will determine if there are more sources which may include media content interests, which may be included in the user profile. If there are more sources, process 1200 will return to step 1210. If there are no more sources, process 1200 will continue to step 1280, where it will determine a reliability metric for each source.

It should be noted that any of the devices or equipment discussed in relation to FIGS. 1-4 could be used to perform one of more of the steps in FIG. 12. It is also contemplated that the steps or descriptions of FIG. 12 may be used with any other embodiment of this disclosure. In addition, the steps and descriptions described in relation to FIG. 12 may be done in alternative orders or in parallel to further the purposes of this disclosure. For example, each of these steps may be performed in any order or in parallel or substantially simultaneously to reduce lag or increase the speed of the system or method.

FIG. 13 is a flowchart of illustrative steps involved in determining the value of a reliability metric in accordance with some embodiments of the disclosure. In some embodiments, FIG. 13 may be a more detailed description of the process of step 550 (FIG. 5). It should be noted that process 1300 refers to determining a reliability metric for each media content interests in a source; however, using the same process a single reliability metric for the source may be determined.

FIG. 13 shows process 1300. At step 1302, process 1300 initializes a counter, and at step 1304, process 1300 initializes a first reliability metric value. For example, process 1300 may initialize the counter by making the value of the counter zero. Likewise, process 1300 may initialize the first reliability metric value by making the first reliability metric zero.

At step 1306, process 1300 retrieves the next media content interests from a particular source (e.g., the first media content interests in the first iteration of process 1300). The media content interests may be arranged in an array of data fields (e.g., as shown in media content interests 710 FIG. 7). Each data field may correspond to a particular media content interest. Process 1300 also retrieves source information for the source of the media content interests (e.g., source information 720 (FIG. 7)). Based on the media content interest in the data field (e.g., data field 712) and the source information (e.g., data field 722), process 1300 assigns a reliability metric value to the data field at step 1308. Process 1300 uses a lookup table to select the particular value. The value in the lookup table may be generated using industry information, historical analysis, past profile information, or any other suitable means to generate a value associated with a measure of whether or not information in a data field indicates a likelihood that the data field is a reliable indicator of the user's media content interests. In addition, a particular data field may be compared to other data fields in the source before a value is assigned in the lookup table as the presence of a combination of values in appearing in different data fields may affect the value assigned in the lookup table.

At step 1310, process 1300 adds the retrieved value to the reliability metric for the media content interests. At step 1312, process 1300 determines whether or not the counter value equals a maximum counter value. If the value does not equal the maximum counter value, process 1300 will add one increment to the counter at step 1314 and return to step 1306. For example, if the first iteration analyzed the first data field in the array of data fields (e.g., data field 712 (FIG. 7) of media content interests 710 (FIG. 7)), then the next data field analyzed may be the next data field in the array of data fields (e.g., data field 714 (FIG. 7)). If the counter value equals the maximum counter value at step 1312, process 1300 generates the reliability metric at step 1316. In some embodiments, generating the reliability metric involves outputting the reliability metric calculated in steps 1302-1314. For instance, the reliability metric generated may equal the sum of all the iterations of retrieved values calculated at step 1310. Specifically, the reliability metric may equal the value assigned to the first data field in the array of data fields (e.g., data field 712 (FIG. 7) in addition to subsequent values assigned to subsequent data fields (e.g., data field 714 (FIG. 7). In other embodiments, generating the reliability metric involves normalizing the sum of all the iterations of retrieved values through suitable methods. For example, process 1300 may express the sum as a percentage of reliability or as a number one (indicating the information is not reliable) through one hundred (indicating the information is very reliable).

Process 1300 may repeat this process for the media content interests from each source. Therefore, each source will have a generated reliability metric. The reliability metric may then be used to indicate the reliability of the user profile. For example, the reliability metric generated by process 1300 may then be compared with a reliability metric threshold (e.g., in step 560 of FIG. 5)). If the reliability metric is above the reliability metric threshold, the media content interests may be used in a generated user profile (e.g., in step 570 (FIG. 5)).

It should be noted that any of the devices or equipment discussed in relation to FIGS. 1-4 could be used to perform one of more of the steps in FIG. 13. It is also contemplated that the steps or descriptions of FIG. 13 may be used with any other embodiment of this disclosure. In addition, the steps and descriptions described in relation to FIG. 13 may be done in alternative orders or in parallel to further the purposes of this disclosure. For example, each of these steps may be performed in any order or in parallel or substantially simultaneously to reduce lag or increase the speed of the system or method.

FIG. 14 is a flowchart of illustrative steps involved in determining and outputting the weighted media content interest value for a user profile in accordance with some of the embodiments of the disclosure. In some embodiments, the reliability metric may be used to generate a particular media content interest. For example, multiple sources may have conflicting information regarding a particular media content interest. In some embodiments, the user profile may include both of the conflicting media content interests. In some embodiments, the user profile may include only a single media content interest value for a particular media content interest. Process 1400 is directed at solving conflicts and providing only a single media content interest value for any particular media content interest in the user profile.

To resolve the conflict, process 1400 weights the media content interests from each of the sources. Sources that are indicated as being more reliable (e.g., have a higher reliability metric) are weighted more heavily than sources that are deemed less reliable (e.g., have a lower reliability metric). Using the weighted average, process 1400 produces a composite media content interest value for each of the media content interests.

In some embodiments, the media content interests include an array of data fields. Each data field corresponds to a particular media content interest (e.g., the user's favorite television channel) as shown in media content interests 710 (FIG. 7). The user profile compiles arrays from multiple sources (e.g., media content interests 710 (FIG. 7) and media content interests 730 (FIG. 7)). In some cases, multiple sources may have a different value for the same media content interest (e.g., two sources identify different movies as the user's favorite movie). For example, data field 714 (FIG. 7) of media content interests 710 (FIG. 7) indicates the user's favorite television show is “Football Re-cap,” while data field 736 of media content interests 730 (FIG. 7) indicates the same user's favorite show is “Kid's Sing-Along.” To solve conflicts, the user profile may present only the media content interest value deemed to be the most reliable (e.g., data field 832 (FIG. 8) of user profile 830 (FIG. 8)). Therefore, the media content interest with the highest reliability metric may be displayed. In cases where there are two sources that indicate the same media content interest value and one source that indicates a different media content value, the reliability metric of the two sources may be added together.

For example, a user profile may contain a composite media content interest value for three sources. The weight of the media content interest value of each source may be determined by process 1300 in FIG. 13. The particular media content interest in question may be the favorite movie genre of the user.

The first source may be from a streaming media website account, and the media content interest value may indicate that the user's favorite movie genre is “horror.” The first source is determined to be highly reliable; therefore, the first source has a high reliability metric. The second source may be from a set-top box, and the media content interest value may indicate that the user's favorite movie genre is “thrillers.” The second source is determined to be not reliable; therefore, the second source has a low reliability metric. The third source may be from a social media webpage account, and the media content interest value may indicate that the user's favorite movie genre is “thrillers.” The third source is determined to be highly reliable; therefore, the third source has a high reliability metric.

The weight may be on a scale of one (being the lowest) to one-hundred (being the highest), so that the weight associated with each of the three sources may be the same or may be different. After the values are inputted into the weighted function, a composite media interest value is determined. For example, assuming highly reliable sources are weighted with a value of three and not reliable sources are weighted with a value of one, in the present case, “thrillers” would have a composite value of four and “horror” would have a composite value of three (as the weight of the sources indicating “thrillers” were added together). Therefore, “thrillers” would be listed as the media content interest value corresponding to the user's favorite movie genre.

Process 1400 begins by initializing several variables. Specifically, process 1400 initializes a counter at step 1402, weight variables at step 1404, each media content interest value at step 1406, and each accumulated media content interests profile value at step 1408. Each of the variables may be stored in an array of one through N entries. For example, process 1400 may describe each iteration beginning with the first iteration and ending with the Nth iteration.

After the counter, weight variables, each media content interest value, and each accumulated media content interest value are initialized in steps 1402, 1404, 1406, and 1408, respectively, process 1400 retrieves a weight based on the counter at step 1412 and a media content interest value based on the counter at step 1414. The particular weight variables and/or media content interest value variables may vary depending on the source. For example, two sources may have different weights and/or media content interest values associated with the same particular media content interest (e.g., two sources stating different movie genres as the favorite movie genre of the user).

At step 1416, process 1400 adds the retrieved weight variable to the appropriate accumulated weight for the media content interest value. For example, the weight variables of source that indicates the same media content interest value are added together. For example, the weight (e.g., based on the reliability metric) of every source that indicates that the user's favorite movie genre is “horror” is added together to generate an accumulated weight for the media content interest that indicates the user's favorite movie genre is “horror.” Alternatively, the weight (e.g., based on the reliability metric) of every source that indicates that the user's favorite movie genre is “comedy” is added together to generate an accumulated weight for the media content interest that indicates the user's favorite movie genre is “comedy.”

At step 1418, the system determines if the counter equals the maximum counter value (e.g., whether there are additional iterations that need to be performed). If there are additional iterations, (e.g., there are more sources from which to retrieve media content interest values), the system may return to steps 1412 and 1414 and repeat the process after increasing the counter by an increment at step 1424. If there are no more iterations (e.g., the counter has reached the maximum N value), the system may determine which media content value has the highest accumulated weight at step 1420.

At step 1422, process 1400 outputs the media content interest value with the highest accumulated weight. This media content interest value may be the value that is included in the user profile that is transmitted to, for example, requester 260 (FIG. 2). In some embodiments, the media content interest value may be normalized through suitable methods. For example, process 1400 may express the media content interest value in a number one (indicating the information has a low accumulated weight) through one hundred (indicating the information has a high accumulated weight).

It should be noted that any of the devices or equipment discussed in relation to FIGS. 1-4 could be used to perform one of more of the steps in FIG. 14. It is also contemplated that the steps or descriptions of FIG. 14 may be used with any other embodiment of this disclosure. In addition, the steps and descriptions described in relation to FIG. 14 may be done in alternative orders or in parallel to further the purposes of this disclosure. For example, each of these steps may be performed in any order or in parallel or substantially simultaneously to reduce lag or increase the speed of the system or method.

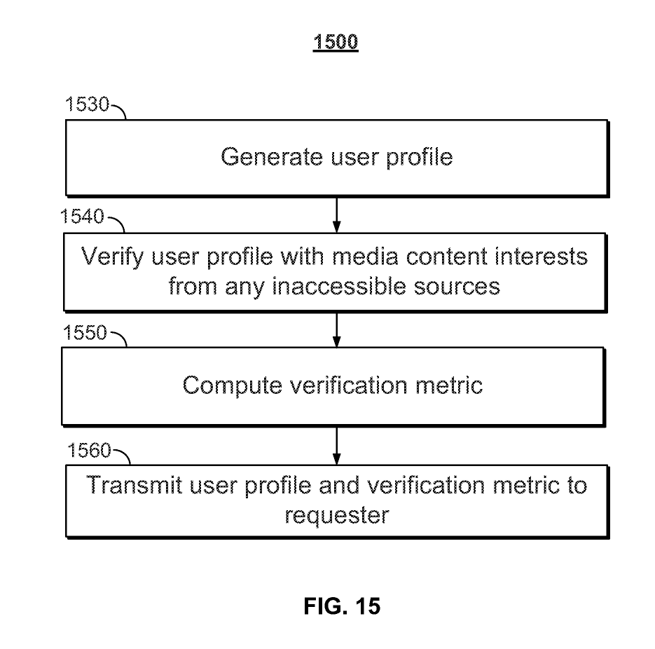

FIG. 15 is a flowchart of illustrative steps involved using media content interests from any non-accessible sources to verify a user profile in accordance with some of the embodiments of the disclosure. Process 1500 is the process for generating and transmitting a verification metric to, for example, the requester 260 (FIG. 2).

At step 1510 of process 1500, a user profile is generated. For example, the user profile could correspond to user profile 830 (FIG. 8). In some embodiments, this step may correspond to step 570 of FIG. 5. Following the generation of the user profile, process 1500 may verify the reliability of the profile. To do so, process 1500 may retrieve media content interests that were inaccessible to the requester as determined in step 530 of FIG. 5. For example, the privacy settings of the media content interests of the user on the source prevented the media content interests of the source to be transmitted to a requester such as line 912 (FIG. 9) prevented lines 922 and 924 from being transmitted in data structure 1000 of FIG. 10.

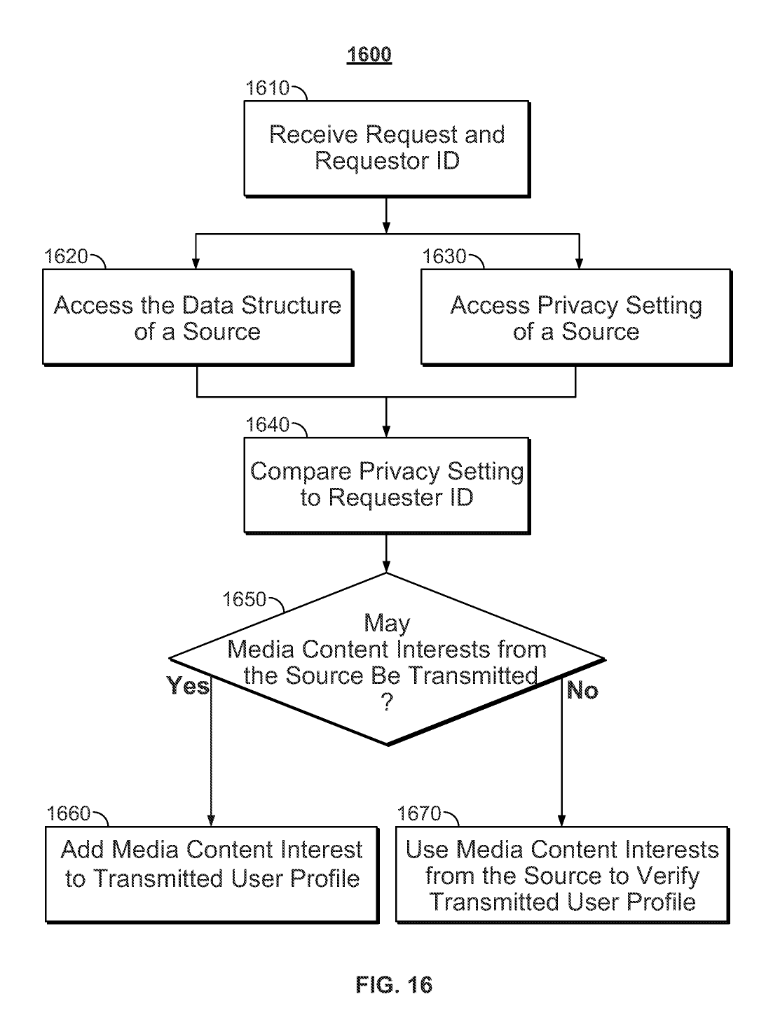

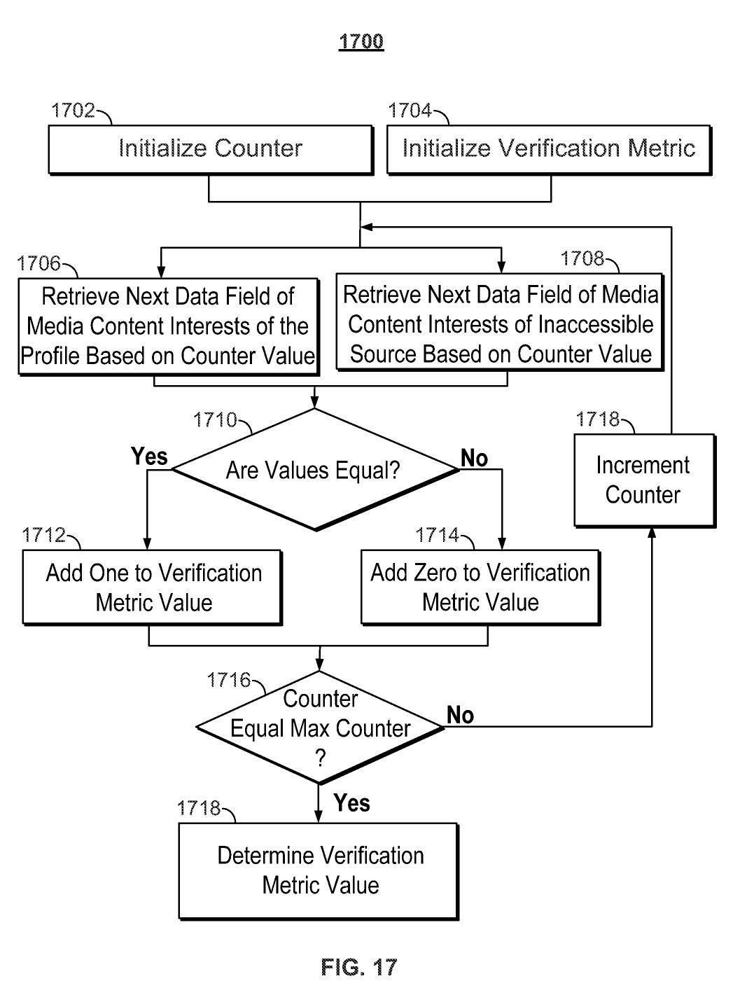

The privacy settings of the media content interests of the user on the source may prevent the media content interests from being transmitted to the requester; however, the media content interests may be used to verify the reliability of the user profile at step 1520 as will be discussed further in relation to FIGS. 16-17. At step 1530, process 1500 may compute a verification metric. The computation of the verification metric will be discussed in more detail in relation to FIG. 17.

At step 1540, process 1500 may transmit the verification metric to the requestor along with the user profile (e.g., user profile 420 (FIG. 4)). It should be noted that any of the devices or equipment discussed in relation to FIGS. 1-4 could be used to perform one of more of the steps in FIG. 15. It is also contemplated that the steps or descriptions of FIG. 15 may be used with any other embodiment of this disclosure. In addition, the steps and descriptions described in relation to FIG. 15 may be done in alternative orders or in parallel to further the purposes of this disclosure. For example, each of these steps may be performed in any order or in parallel or substantially simultaneously to reduce lag or increase the speed of the system or method.

FIG. 16 is a flowchart of illustrative steps involved in using media content interests from any inaccessible sources to verify a user profile in accordance with some of the embodiments of the disclosure.

At step 1610, process 1600 receives a request and a requester identifier. In some embodiments, this step includes receiving, at a profile clearinghouse server (e.g., profile clearinghouse server 202 (FIG. 2)), a query from a requester (e.g., requester 260 (FIG. 2)) for a user profile including a user's media content interests, and data packets including a requester identifier (e.g., requester identifier 266 (FIG.)). In some embodiments, this step may be performed by a receiving module 206 (FIG. 2).

At step 1620, process 1600 accesses the data structure of a source, and at step 1630, process 1600 accesses a privacy setting of the source. In some embodiments, these steps include accessing a data structure of a first source (e.g., data structure 900 (FIG. 9) including first media content interests (e.g., line 918 (FIG. 9)) and a privacy setting (e.g., line 912 (FIG. 9)). In some embodiments, these steps include using an accessing module (e.g., accessing module 208 (FIG. 2)) configured to access a data structure (e.g., data structure 900 (FIG. 9)) of a first source including first media content interests (e.g., line 918 (FIG. 9)) and a privacy setting (e.g., line 912 (FIG. 9)).

At step 1640, process 1600 compares the privacy setting to the requester identifier. At step 1650, process 1600 may determine whether or not the media content interests from the source may be transmitted in the user profile. In some embodiments, these steps includes comparing the data packets, including the requester identifier (e.g., requester identifier 266 (FIG. 2)) to the privacy setting to determine whether the requester has access to the first source. In some embodiments, these steps include using a comparing module (e.g., comparing module 210 FIG. 2)) configured to compare the data packets to the privacy setting to determine whether the requester (e.g., requester 260 (FIG. 2)) has access to the first source.

At step 1660, if process 1600 determined the media content interest from the first source may be transmitted in the user profile at step 1650, process 1600 may add the media content interests from the source to the user profile ultimately transmitted to the requester. In some embodiments, this step includes retrieving the first media content interests (e.g., line 918 (FIG. 9)) from the data structure of the first source (e.g., data structure 900 (FIG. 9)) in response to determining the requester (e.g., requester 260 (FIG. 2)) has access to the first source (e.g., source A 240 (FIG. 2)). In some embodiments, this step includes using a retrieving module (e.g., retrieving module 206 (FIG. 2)) configured to retrieve the first media content interests from the data structure (e.g., data structure 900 (FIG. 9)) of the first source in response to determining the requester (e.g., requester 260 (FIG. 2)) has access to the first source (e.g., source A 240 (FIG. 2)).

In contrast, at step 1670, if process 1600 determined the media content interest form the first source may be transmitted in the user profile at step 1650, process 1600 may use the media content interests from the source to verify the reliability of the user profile transmitted to the requester. Some embodiments of using media content interests to verify the reliability of the user profile are discussed in relation to FIG. 17 below.

It should be noted that any of the devices or equipment discussed in relation to FIGS. 1-4 could be used to perform one of more of the steps in FIG. 16. It is also contemplated that the steps or descriptions of FIG. 16 may be used with any other embodiment of this disclosure. In addition, the steps and descriptions described in relation to FIG. 16 may be done in alternative orders or in parallel to further the purposes of this disclosure. For example, each of these steps may be performed in any order or in parallel or substantially simultaneously to reduce lag or increase the speed of the system or method.

FIG. 17 is a flowchart of illustrative steps involved in determining a verification metric by using media content interests from any non-accessible sources to verify a user profile in accordance with some of the embodiments of the disclosure. It should be understood that process 1700 is just one embodiment and that other suitable methods may be used.

At step 1702, process 1700 initializes the counter. At step 1704, process 1700 initializes the verification metric. For example, the counter and verification metric may be initialized by setting their value to zero. The counter will be used to track the progression of process 1700 through the array of data fields of the user profile (e.g., as shown in user profile 830 (FIG. 8) and of the verification data, which may also be arranged in an array. The verification metric will be a value used to describe reliability of the media content interests generated in step 570 (FIG. 5) in view of media content interests from a source the requester did not have access to (e.g., as determined by step 1650 of FIG. 16).

At step 1706, process 1700 retrieves the next data field of media content interests of the profile based on the counter value. For example, the user profile may include the media content interests of the user profile in an array. Profile clearinghouse server 202 (FIG. 2) may arrange the media content interests from the inaccessible source into a corresponding array. For example, if the first data field of the user profile includes data regarding the favorite show of the user, the data field for the favorite show of the user, if any, of the inaccessible media content interests will be placed in the first data field of the inaccessible media content interests array. Process 1700 will compare the first data field (e.g., favorite show) of the profile to the first data field (e.g., favorite show) from the inaccessible media content interests.

At step 1708, the process 1700 retrieves a corresponding data field of media content interests from a source that was inaccessible based on the counter value. At step 1710, process 1700 compares the first data field of the media content interests of the user profile and the corresponding data field of media content interests from the inaccessible source. The system may use multiple types of object recognition, including fuzzy logic. For example, the particular data field may be a textual data field. Using fuzzy logic, the system may determine two fields to be identical even though the substance of the data field (e.g., two different spellings) is not identical. In some embodiments, the profile clearinghouse server 202 (FIG. 2) may analyze particular data fields for particular values or text. The data fields could be associated with categories, genres, series, episodes, products, traits, ratings, targeted audiences, textual descriptions, or any other suitable indicator. Furthermore, the data fields could contain values (e.g., the data fields could be expressed in binary or any other suitable code or programming language).

If the first data field of the media content interests of the user profile equals the corresponding data field of the media content interests from the inaccessible source, process 1700 adds a value to the verification metric at step 1712. If the first data field of the media content interests of the user profile and the corresponding data field of the media content interests from the inaccessible source are not equal, process 1700 does not add a value to the verification metric at step 1774. In some embodiments, the amount of the value may be one. In some embodiments, the amount of the value may depend on the iteration (e.g., the particular counter number). For example, a particular counter number or data field may relate to a particular attribute that should be given more or less weight in the verification metric.

At step 1716, the process 1700 determines if the counter has reached its maximum value. If the counter has not reached the maximum value, process 1700 continues to step 1718, which adds an increment to the counter, and returns to steps 1706 and 1708. If the counter has reached the maximum value, the process 1700 determines the value of the verification metric at step 1718.

It should be noted that any of the devices or equipment discussed in relation to FIGS. 1-4 could be used to perform one of more of the steps in FIG. 17. It is also contemplated that the steps or descriptions of FIG. 17 may be used with any other embodiment of this disclosure. In addition, the steps and descriptions described in relation to FIG. 17 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel.

1. A method for profiling a user's media content interests, comprising:
receiving, at a profile clearinghouse server, a query from a requester for a user profile comprising a user's media content interests, wherein the query includes a requester identifier;
accessing a first data structure of a first source comprising first media content interests and a privacy setting;
comparing the requester identifier to the privacy setting to determine whether the requester has access to the first source;
in response to determining the requester has access to the first source, retrieving the first media content interests from the data structure of the first source;
generating a first reliability metric from the first source, wherein the first reliability metric indicates a likelihood that the first media content interests are indicative of the user's media content interests;
comparing the first reliability metric to a reliability metric threshold; and
in response to determining the reliability metric exceeds the reliability metric threshold, generating the user profile for transmission to the requester based at least in part on the first media content interests.

2. The method of claim 1, further comprising accessing a second source, wherein the second source has second media content interests, and wherein the generated user profile is based at least in part on the second media content interests from the second source.

3. The method of claim 2, wherein the first source and the second source are of a different type.

4. The method of claim 2, wherein generating the user profile further comprises weighting the first media content interests based on the first reliability metric and weighting the second media content interests based on a second reliability metric.

5. The method of claim 4, wherein the user profile comprises composite media content interests based on the weighted first media content interests and the weighted second media content interests.

6. The method of claim 1, wherein the user profile includes a numerical indication of the reliability that the media content interests in the user profile are indicative of the media content interests of the user.

7. The method of claim 1, further comprising generating verifying media content interests, used to verify the reliability of the user profile, from inaccessible sources.

8. The method of claim 7, wherein generating verifying media content interests comprises generating a verification metric, wherein the verification metric indicates a consistency between the media content interests in the user profile and the verifying media content interests.

9. The method of claim 1, further comprising identifying sources comprising media content interests related to the user from a plurality of sources by comparing the consistency of media content interests of the user at the profile clearinghouse server and media content interests of the user at the plurality of sources.

10. The method of claim 1, wherein generating a first reliability metric from the first source comprises using a lookup table to assign a value to information received about the source.

11. A system for profiling a user's media content interests at a profile clearinghouse server, comprising:
a receiving module configured to receive a query from a requester for a user profile comprising a user's media content interests, wherein the query includes a requester identifier;
an accessing module configured to access a first data structure of a first source comprising first media content interests and a privacy setting;
a comparing module configured to compare the requester identifier to the privacy setting to determine whether the requester has access to the first source;
a retrieving module configured to retrieve the first media content interests from the data structure of the first source in response to determining the requester has access to the first source;
an generation module configured to generate a first reliability metric from the first source, wherein the first reliability metric indicates a likelihood that the first media content interests are indicative of the user's media content interests;
a reliability module configured to compare the first reliability metric to a reliability metric threshold; and
an output module configured to generate the user profile for transmission to the requester based at least in part on the first media content interests in response to determining the reliability metric exceeds the reliability metric threshold.

12. The system of claim 11, further comprising a second source, wherein the second source has second media content interests, and wherein the generated user profile is based at least in part on the second media content interests from the second source.

13. The system of claim 12, wherein the first source and the second source are of a different type.

14. The system of claim 12, wherein generating the user profile further comprises weighting the first media content interests based on the first reliability metric and weighting the second media content interests based on a second reliability metric.

15. The system of claim 14, wherein the user profile comprises composite media content interests based on the weighted first media content interests and the weighted second media content interests.

16. The system of claim 11, wherein the user profile includes a numerical indication of the reliability that the media content interests in the user profile are indicative of the media content interests of the user.

17. The system of claim 11, wherein the output module is further configured to generate verifying media content interests, used to verify the reliability of the user profile, from inaccessible sources.

18. The system of claim 17, wherein generating verifying media content interests comprises generating a verification metric, wherein the verification metric indicates a consistency between the media content interests in the user profile and the verifying media content interests.

19. The system of claim 11, wherein the accessing module is further configured to identify sources comprising media content interests related to the user from a plurality of sources by comparing the consistency of media content interests of the user at the profile clearinghouse server and media content interests of the user at the plurality of sources.

20. The system of claim 11, wherein generating a first reliability metric from the first source comprises using a lookup table to assign a value to information received about the source.

21-30. (canceled)
